(19) United States
(12) Patent Application Publication
(10) Pub. No.: US 2021/0026745 A1
(43) Pub. Date: Jan. 28, 2021

(54) METHODS, SYSTEMS, AND COMPUTER READABLE MEDIA FOR PROVIDING BYZANTINE FAULT TOLERANCE

(71) Applicant: The University of North Carolina at Charlotte, Charlotte, NC (US)

(72) Inventor: Yongge Wang, Matthews, NC (US)

(21) Appl. No.: 16/911,876

(22) Filed: Jun. 25, 2020

Related U.S. Application Data
(60) Provisional application No. 62/877,942, filed on Jul. 24, 2019.
(60) Provisional application No. 62/948,752, filed on Dec. 16, 2019.

(51) Int. Cl. G06F 11/18; G06F 11/20; G06F 11/16; H04L 29/06; H04L 9/06

(52) U.S. Cl. CPC G06F 11/183; G06F 11/2023; H04L 2209/38; H04L 63/1416; H04L 9/0643; G06F 11/1633

(57) ABSTRACT

Methods, systems, and computer readable media for providing Byzantine fault tolerance (BFT) are disclosed. According to one method, a method for providing BFT occurs at a computing platform executing a BFT protocol, wherein the computing platform is acting as a leader participant of a round of the BFT protocol. The method comprising: receiving signed round-change messages from multiple participants in the round; broadcasting a signed lock message indicating that signed round-change messages have been received from a predetermined number of the participants in the round voting for a same candidate block; receiving signed commit messages from multiple participants in the round; and broadcasting a signed decide message indicating the candidate block is a finalized block after the predetermined number of the participants in the round have sent signed commit messages indicating the candidate block.

### CROSS-REFERENCE TO RELATED APPLICATIONS

This application relates to and claims priority to U.S. Provisional Patent Application Ser. No. 62/877,942 filed Jul. 24, 2019 and 62/948,752 filed Dec. 16, 2019, the disclosures of which are incorporated by reference herein in their entireties.

### TECHNICAL FIELD

The subject matter described herein relates to data processing. More specifically, the subject matter relates to methods, systems, and computer readable media for providing Byzantine fault tolerance (BFT).

### BACKGROUND

Computer systems may involve multiple components or parts that can cause faults or failures. For example, a distributed computing system may involve computers that share data storage and are connected via links and network devices. In this example, one or more components in the distributed computing system may fail and may be referred to as a Byzantine fault because the fault and its related symptoms appear differently to different observers (e.g., other system components).

Byzantine fault tolerance (BFT) generally refers to the ability of a computing system or a related application to handle Byzantine faults. For example, a Byzantine fault (e.g., a misconfigured or malfunctioning authentication module) may appear as faulty to only some components of the system. In this example, other components of the system may be unable to identify or note the fault and, as such, those components may assume that the system is working normally. Continuing with this example, a computing system that provides Byzantine fault tolerance may be able to avoid Byzantine failure (e.g., a system failure due to a Byzantine fault) because the computing system may use a fault detection mechanism which can achieve agreement among various system components about whether a Byzantine fault is occurring and then act accordingly.

One mechanism for providing BFT may include utilizing a BFT protocol such that system components can reach consensus regarding potential Byzantine faults. However, issues exist in many known BFT protocols. For example, various BFT protocols are susceptible to attacks that cause system deadlocks, thereby preventing consensus and negatively impacting those systems' performances.

### SUMMARY

Methods, systems, and computer readable media for providing Byzantine fault tolerance (BFT) are disclosed. According to one method, a method for providing BFT occurs at a computing platform executing a BFT protocol, wherein the computing platform is acting as a leader participant of a round of the BFT protocol. The method comprising: receiving signed round-change messages from multiple participants in the round; broadcasting a signed lock message indicating that signed round-change messages have been received from a predetermined number of the participants in the round voting for a same candidate block; receiving signed commit messages from multiple participants in the round; and broadcasting a signed decide message indicating the candidate block is a finalized block after the predetermined number of the participants in the round have sent signed commit messages indicating the candidate block.

According to one system, a system for providing BFT includes at least one processor and a computing platform implemented using the at least one processor. The computing platform is executing a BFT protocol and is acting as a leader participant of a round of the BFT protocol. The computing platform is configured for: receiving signed round-change messages from multiple participants in the round; broadcasting a signed lock message indicating that signed round-change messages have been received from a predetermined number of the participants in the round voting for a same candidate block; receiving signed commit messages from multiple participants in the round; and broadcasting a signed decide message indicating the candidate block is a finalized block after the predetermined number of the participants in the round have sent signed commit messages indicating the candidate block.

The subject matter described herein can be implemented in software in combination with hardware and/or firmware. For example, the subject matter described herein can be implemented in software executed by a processor. In one example implementation, the subject matter described herein may be implemented using a computer readable medium having stored thereon computer executable instructions that when executed by the processor of a computer cause the computer to perform steps. Example computer readable media suitable for implementing the subject matter described herein include non-transitory devices, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

As used herein, each of the terms “node” and “host” refers to a physical computing platform or device including one or more processors and memory.

As used herein, the term “module” refers to hardware, firmware, or software in combination with hardware and/or firmware for implementing features described herein.

### BRIEF DESCRIPTION OF THE DRAWINGS

The subject matter described herein will now be explained with reference to the accompanying drawings of which:

FIG. 1 depicts a table containing information about different Byzantine fault tolerance (BFT) protocols;

FIGS. 2A-2C depict portions of a block diagram illustrating a BFT consensus algorithm;

FIGS. 3A-3C depict tables containing information for various test scenarios involving an example BFT implementation;

FIG. 4 is a block diagram illustrating an example computer system for providing BFT; and

FIG. 5 is a diagram illustrating an example process for providing BFT.

### DETAILED DESCRIPTION

The subject matter described herein relates to methods, systems, and computer readable media for providing Byzantine fault tolerance (BFT).

1 Introduction

Lamport, Shostak, and Pease [14] and Pease, Shostak, and Lamport [15] initiated the study of reaching consensus in the face of Byzantine failures and designed the first synchronous solution for Byzantine agreement. Dolev and Strong [8] proposed an improved protocol in a synchronous network with O(n³) communication complexity. By assuming the existence of digital signature schemes and a public-key infrastructure, Katz and Koo [12] proposed an expected constant-round BFT protocol in a synchronous network setting against

$$[ \frac{n - 1}{2} ]$$

Byzantine faults.

For an asynchronous network, Fischer, Lynch, and Paterson [10] showed that there is no deterministic protocol for the BFT problem in face of a single failure in an asynchronous network. Their proof is based on a diagonalization construction and has two assumptions: (1) when a process writes a bit on the output register, it is finalized and cannot change anymore; and (2) an honest process runs infinitely many steps in a run. Several researchers have tried to design BFT consensus protocols to circumvent the impossibility. For example, to circumvent this impossibility result, Ben-Or [1] initiated the probabilistic approach to BFT consensus protocols in completely asynchronous networks and Dwork, Lynch, and Stockmeyer [9] designed BFT consensus protocols in partial synchronous networks. Castro and Liskov [5] initiated the study of practical BFT (PBFT) consensus protocol design and introduced the PBFT protocol for partial synchronous networks. The core idea of PBFT has been used in the design of several widely adopted BFT systems such as Tendermint BFT [3]. Tendermint BFT has been used in more than 40% Proof of State blockchains (see, e.g., [13]) such as the “Internet of Blockchain” Cosmos [6]. More recently, Yin et al [20] improved the PBFT/Tendermint protocol by changing the mesh communication network in PBFT to hub-like (or star) communication networks in HotStuff and by using threshold cryptography. Facebook's Libra blockchain has adopted HotStuff in their LibraBFT protocol [17].

There are generally two kinds of partial synchronous networks for Byzantine Agreement protocols. In Type I partial synchronous networks, all messages are guaranteed to be delivered. In this type of networks, Denial of Service (DoS) attacks are not allowed and reliable point to point communication channels for all pairs of participants are required for the underlying networks. In Type II partial synchronous networks, the network becomes synchronous after an unknown Global Synchronization Time (GST). In this type of networks, Denial of Service (DoS) attacks are allowed before GST though it is not allowed after GST. The Type II network is more realistic and is commonly used in the literature.

Several partial synchronous network models for BFT design assume the existence of reliable broadcast communication channels for certain message transmission. In particular, these protocols normally leverage the gossip-based broadcast protocol in Bracha [2] which is based on the existence of reliable point-to-point communication channels for all pairs of participants. In particular, the broadcast protocol in Bracha [2] assumes a complete network to achieve “a reliable message system in which no messages are lost or generated”. Since our Internet infrastructure is not a complete network, one needs to be very careful in building Internet based BFT protocols using Bracha's results. Specifically, one should not assume that there is a reliable broadcast channel before GST of Type II networks.

The subject matter described herein shows that one can launch attacks against several widely deployed BFT protocols (e.g., Tendermint BFT, Ethereum's Casper FFG, and GRANDPA BFT [11]) so that participants reach a deadlock before GST and the deadlock cannot be removed after GST. Thus, after such attacks, the participants can never reach an agreement even after GST. That is, these BFT protocols cannot achieve the liveness property in type II partial synchronous networks. For Type I networks, one does not know when the message could be delivered. Thus the broadcast protocol may be “unreliable” until the end of a fixed unknown time period. That is, the same attack in the Type II networks could be used to show that these protocol will reach deadlock before the end of this unknown time period. On the other hand, all these protocols will change views after certain timeout and after a view change, participants would not accept messages from previous views. That is, even all messages are delivered at the end of this unknown time period, participants discard these messages if they have changed views already. Thus these protocols will remain deadlocked. In a summary, our attacks show that these BFT protocols are insecure in all types of partial synchronous networks (including both Type I and Type II networks).

It should also be noted that though Tendermint [3] BFT protocol claims security in Type II asynchronous networks, it actually uses a Type I network model since it assumes a reliable point to point communication channel for each pair of participants in the network and no message is ever lost (including messages before GST). However, our discussion in the preceding paragraph shows that Tendermint is not secure in the Type I networks either. It should also be noted that in the first version of the LibraBFT specification (accessed on Jul. 19, 2019), its network model is a Type II partial synchronous network. In the current version [17] of the LibraBFT specification (dated as Nov. 8, 2019 and accessed on Feb. 9, 2020), its network model is essentially a Type I partial synchronous network since all messages are delivered in the end (see pages 3 of Section 2 in [17]).

Based on the security requirement analysis for BFT protocols in asynchronous networks, we propose a BFT finality gadget protocol for blockchains, referred to herein as Blockchain DLS (BDLS). It should be noted that the first BFT protocol (i.e., the DLS protocol) for Type II networks was proposed by Dwork, Lynch, and Stockmeyer [9]. DLS protocol leverages a star network where participants only exchange messages via round leaders. The PBFT protocol allows all participants to broadcast their messages to all other participants. By leveraging this kind of mesh network, PBFT protocol was able to achieve consensus with reduced round complexity. By leveraging the lock-mechanisms in PBFT/Tendermint BFT protocols and changing the mesh network back to star network, HotStuff BFT/LibraBFT is able to achieve consensus with reduced communication complexity but increased round complexity. The BDLS protocol described herein is based on the original DLS protocol [9] and is able to achieve consensus with both reduced round complexity and reduced communication complexity. Specifically, BDLS has the same round complexity as PBFT and has reduced communication complexity than HotStuff BFT/LibraBFT. BDLS is proved to be secure in Type II partial synchronous networks and achieves the best performance among existing BFT protocols for blockchains. Though both BDLS and HotStuff BFT leverages star networks, BDLS employs the lock-mechanisms used in DLS protocol while HotStuff employs the lock-mechanisms used in PBFT/Tendermint BFT protocols. Thus BDLS could achieve consensus in 4 steps while HotStuff requires 7 steps to achieve consensus in synchrony.

2 Synchronous, Asynchronous, and Partial Synchronous Networks

Assume that the time is divided into discrete units called slots

T₀, T₁, T₃ . . . where the length of the time slots are equal. Furthermore, we assume that: (1) the current time slot is determined by a publicly-known and monotonically increasing function of current time; and (2) each participant has access to the current time. In a synchronous network, if an honest participant P₁ sends a message m to a participant P₂ at the start of time slot Tᵢ_{₁}, the message m is guaranteed to arrive at P₂ at the end of time slot Tᵢ. In the complete asynchronous network, the adversary can selectively delay, drop, or re-order any messages sent by honest parties. In other words, if an honest participant P₁ sends a message m to a participant P₂ at the start of time slot Tᵢ_{₁}, P₂ may never receive the message m or will receive the message m eventually at time Tᵢ_{₂} where i₂=i₁+Δ. Dwork, Lynch, and Stockmeyer [9] considered the following two kinds of partial synchronous networks:
Type I asynchronous network: Δ<∞ is unknown. That is, there exists a A but the participants do not know the exact value of Δ.
Type II asynchronous network: Δ<∞ holds eventually. That is, the participant knows the value of Δ. But this Δ only holds after an unknown time slot T=Tᵢ. Such a time T is called the Global Stabilization Time (GST).

For Type I asynchronous networks, the protocol designer supplies the consensus protocol first, then the adversary chooses her Δ. For Type II asynchronous networks, the adversary picks the Δ and the protocol designer (knowing Δ) supplies the consensus protocol, then the adversary chooses the GST. The definition of partial synchronous networks in [5, 20, 17] is the second type of partial synchronous networks. That is, the value of Δ is known but the value of GST is unknown. In such kind of networks, the adversary can selectively delay, drop, or re-order any messages sent by honest participants before an unknown time GST. But the network will become synchronous after GST. Several BFT protocols in the literature (e.g., Tendermint, GRANDPA, and the current version of LibraBFT dated on Nov. 8, 2019) uses Type II networks, but they also assume that no message gets lost. With this additional assumption, the network is actually a Type I network since all messages are delivered within a time period GST+Δ where GST is unknown and Δis known.

For the Type I network model, Denial of Service (DoS) attack is not allowed since message could be lost with DoS attacks. We think that it is more natural to use Type II asynchronous networks for distributed BFT protocol design and analysis. Thus the subject matter described herein generally refers to Type II network scenarios.

3 Reliable Broadcast Communication Channels

The difference between point-to-point communication channels and broadcast communication channels has been extensively studied in the literature. A reliable broadcast channel requires that the following two properties be satisfied.
1. Correctness: If an honest participant broadcasts a message m, then every honest participant accepts m.
2. Unforgeability: If an honest participant does not broadcast a message m, then no honest participant accepts m.

For complete networks, reliable broadcast protocols have been proposed in Bracha [2]. For a given integer k, a network is called k-connected if there exist k-node disjoint paths between any two nodes within the network. In non-complete networks, it is well known that (2t+1)-connectivity is necessary for reliable communication against t Byzantine faults (see, e.g., Wang and Desmedt [19] and Desmedt-Wang-Burmester [7]). On the other hand, for broadcast communication channels, Wang and Desmedt [18] showed that there exists an efficient protocol to achieve probabilistically reliable and perfectly private communication against t Byzantine faults when the underlying communication network is (t+1)-connected. The crucial point to achieve these results is that: in a point-to-point channel, a malicious participant P₁ can send a message m₁ to participant P₂ and send a different message m₂ to participant P₃ though, in a broadcast channel, the malicious participant P₁ has to send the same message m to multiple participants including P₂ and P_{3.} If a malicious P₁ sends different messages to different participants in a reliable broadcast channel, it will be observed by its neighbors.

Though broadcast channels at physical layers are commonly used in local area networks, it is not trivial to design reliable broadcast channels over the Internet infrastructure since the Internet connectivity is not a complete graph and some direct communication paths between participants are missing (see, e.g., [14, 19]). Quite a few broadcast primitives have been proposed in the literature using message relays (see, e.g., Srikanth and Toueg [16], Bracha [2], and Dwork-Lynch-tockmeyer [9]). In the message relay based broadcast protocol, if an honest participant accepts a message signed by another participant, it relays the signed message to other participants. However, in order for these message relay based broadcast protocol to be reliable, it requires that the network graph is complete which is not true for the Internet environments.

A broadcast channel is unreliable if a malicious participant could broadcast a message m₁ to a proper subset of the participants but not to other participants. That is, some participants will receive the message m₁ while other participants will receive a different message m₂ or receive nothing at all. In next sections, we show that several BFT protocols are insecure due to the lack of reliable broadcast channels before GST (messages before GST could get lost or re-ordered by the definition). Thus it is important to design BFT protocols that could tolerate unreliable broadcast channels before GST.

In the following sections, if not specified explicitly, we will assume that there are n=3t+1 participants P₀, . . . , Pₙ₋₁ for the BFT protocol and at least t of them are malicious. Furthermore, we assume that each participant has a public and private key pair where the public key is known to all participants. We use the notation <⋅>ᵢ to denote that the message is digitally signed by the participant Pᵢ.

4 Security Analysis of Tendermint BFT Protocol

Buchman, Kwon, and Milosevic [3] initiated the study of BFT protocols as a finality gadget for blockchains. Specifically, the authors in [3] proposed Tendermint BFT as an overlay atop a block proposal mechanism.

4.1 Tendermint BFT Protocol

Tendermint BFT protocol [3] is based on the PBFT protocol. In Tendermint BFT, there are n=3t+1 participants P₀, . . . , Pₙ₋₁ and at most t of them are malicious. Each participant maintains five variables step, lockedV, lockedR, validV, and ValidR throughout the protocol run. For each blockchain height h, the protocol runs from round to round until it reaches an agreement for the height h. Then the protocol moves to the next blockchain height. For each round, it contains three steps: propose, pre vote, and precommit. For each height h, the participants start the process by initializing their five variables to: step=propose, lockedV=nil, lockedR=−1, validV=nil, and ValidR=−1. Then it starts from round 0 until an agreement is reached for the height h. There is a public function proposer(h,r) that returns the round leader for a given round r of the height h. The round r of the height h proceeds as follows:
1. propose: The leader Pᵢ=proposer(h,r) distinguishes the two cases:
   r=0 or validV=nil: Pᵢ chooses her proposal v and vr=−1.
   r>0 and validV≠nil: Pᵢ lets v=validV and vr=ValidR Pᵢ broadcasts the signed message

[symbol]

PROPOSAL,h,r,v,vr [symbol] ᵢ (1)

to all participants. All other participants Pⱼ initialize the timeout counter to execute OnTimeoutPropose(h,r).
2. prevote: For all participants Pⱼ who are in step=propose, Pⱼ distinguishes the following three cases:
   Pⱼ receives (1) with vr=−1. If lockedR=−1 or validV=v, then Pⱼ broadcasts the message [symbol] PREVOTE,h,r,H(v) [symbol] j Otherwise, Pⱼ broadcasts the message [symbol] PREVOTE,h,r,nil [symbol] j. Pⱼ sets step=prevote.
   Pⱼ receives (1) with vr≥0 and Pⱼ has received 2t+1 [symbol] PREVOTE,h,vr,H(v) [symbol] . Pⱼ distinguishes the following two cases
      lockedR≤vr or lockedV=v: Pⱼ broadcasts [symbol] PREVOTE,h,r,H(v) [symbol] j
      Otherwise: Pⱼ broadcasts the message [symbol] PREVOTE,h,r,nil [symbol] j.
   Pⱼ sets step=prevote.
   Pⱼ receives (1) with vr≥0 though Pⱼ has not received 2t+1 [symbol] PREVOTE,h,vr,H(v) [symbol] . Pⱼ does nothing.
3. precommit:
   (a) As soon as a participant Pⱼ in step prevote receives 2t+1 messages [symbol] PREVOTE,h,r,* [symbol] for the first time, Pⱼ initializes timeout counter to execute OnTimeoutPrevote(h,r).
   (b) As soon as a participant Pⱼ in step prevote receives 2t+1 messages [symbol] PREVOTE,h,r,nil [symbol] for the first time, Pⱼ broadcasts [symbol] PRECOMMIT,h,r,nil [symbol] and sets step=precommit.
   (c) If Pⱼ is in step prevote V precommit, has received the proposal (1), and has received 2t+1 messages [symbol] PREVOTE,h,r,H(v) [symbol] , then Pⱼ carries out the following steps
      If step=prevote, then Pⱼ sets lockedV=v, lockedR=r, broadcasts [symbol] PRECOMMIT,h,r,H(v) [symbol] , and sets step=precommit.
      Pⱼ sets validV=v and validR=r.
4. decision: As soon as a participant Pⱼ receives 2t+1 messages [symbol] PRECOMMIT,h,r,* [symbol] for the first time, Pⱼ initializes timeout counter to execute OnTimeoutPrecommit(h,r). If Pⱼ has not decided a value for the height h, has received the proposal (1), and has received 2t+1 messages [symbol] PRECOMMIT,h,r,H(v) [symbol] , then Pⱼ sets v as the decision value for height h, resets values for the five variables, and goes to round 0 of height h+1.
5. automatic update round: During any time of the protocol, if a participant Pⱼ receives t+1 messages for a round r′>r, Pⱼ moves to round r′.
6. Timeout functions:
   (a) OnTimeoutPropose(h,r): broadcast [symbol] PREVOTE,h,r,nil [symbol] and set step=prevote.
   (b) OnTimeoutPrevote(h,r): broadcast [symbol] PRECOMMIT,h,r,nil [symbol] and set step=precommit.
   (c) OnTimeoutPrecommit(h,r): move to round r+1 of height h.

4.2 Attacks on Tendermint BFT Protocol

In this section, we show that Tendermint BFT does not achieve the liveness property in partial synchronous networks. We describe our attack in the Type II networks where the broadcast channel is unreliable before GST.

Specifically, we show that if a malicious participant could choose to broadcast a message to a subset of the users before GST, then the system will reach a deadlock and no new block will be created anymore (even after GST). In other words, the Tendermint BFT will reach deadlock before GST and the deadlock could not be removed after GST. We then extend these attacks on

Tendermint BFT to Type I networks. For simplicity, we assume that for a given height h, the leader participant is P₀ and the participants in P₁={P₀, . . . , Pₜ₋₁} are malicious. Furthermore, let P_{2={}Pₜ, . . . , P₂ₜ}, and P₃={P₂ₜ₊₁, . . . , P₃ₜ}.

Attack 1. In round 0 of height h, P₀ chooses a minimal valid value v and broadcasts [symbol] PROPOSAL,h,0,,v,−1 [symbol] to participants in P₁∪P₂. After receiving [symbol] PROPOSAL,h,0,,v,−1 [symbol] from P₀, each participant P₁∈P₁ broadcasts [symbol] PREVOTE,h,0,H(v) [symbol] to participants in P₂ and each participant Pⱼ∈P₂ broadcasts [symbol] PREVOTE,h,0,H(v) [symbol] to all participants and sets step=prevote. Each participant Pⱼ∈P₂ receives 2t+1 messages [symbol] PREVOTE,h,0,H(v) [symbol] . Thus the participant Pⱼ∈P₂ sets lockedV=v, lockedR=0, step=precommit, validV=v, validR=0, and then broadcasts [symbol] PRECOMMIT,h,0,H(v) [symbol] . Since each participant receives at most t+1 pre-commit messages for the value v, no decision will be made during the round 0. After timeout for round 0, all participants moves to round 1 of height h. The participants in P₁ will become dormant from now on. If a participant in P₂ becomes the leader of round 1, it will broadcast the proposal [symbol] PROPOSAL,h,1,v,0 [symbol] . Since participant Pⱼ in P₃ has received at most t+1 prevote messages for the value v in round 0, Pⱼ will do nothing until timeout. Thus no honest participant can collect sufficient prevote messages for v to move ahead. After timeout for round 1, the system will move to round 2 of height h. On the other hand, if a participant Pⱼ in P₃ becomes the leader of round 1, it will broadcast the proposal [symbol] PROPOSAL,h,1,v′,−1 [symbol] . Since P₀ has selected the value v as the minimal valid value and new transactions have been inserted into the system since then, the honest leader for round 1 will select a valid value v′≠v with high probability. Thus participants in P₂ will not accept the proposal for v′ and will broadcast [symbol] PROVOTE,h,1,nil [symbol] . That is, no agreement could be made during round 1 and the system will move to round 2 of height h after timeout. This process will continue forever without making an agreement for the height h even after GST.

Attack 2. One can launch an attack on Tendermint BFT so that some participants in P₂ will decide on a value v for the height h (though no participant in P₃ decides on any value for the height h) and then the system moves to the deadlock. It is noted that due to the lock function in Tendermint BFT and due to the blockchain property, the adversary will not be able to let the participants in P₃ to decide on a different value for the height h or h+1.

In the preceding Attack 1, the malicious user needs to control t participants in the set P₁. Indeed, we can revise the attack in such a way that the malicious user only needs to control one user P₀ to launch a similar attack. We use the same set P₁, P_{2,} P_{3.} But this time, we assume that only the leader P₀ is malicious and all other participants are honest.

Attack 3. In round 0 of height h, P₀ chooses a minimal valid value v and broadcasts [symbol] PROPOSAL,h,0,,v,−1 [symbol] to participants in P₁∪P₂. P₀ then broadcasts [symbol] PREVOTE,h,0,H(v) [symbol] to participants in P₁∪P₂ and becomes dormant. After receiving [symbol] PROPOSAL,h,0,v,−1 [symbol] from P₀, each participant Pⱼ∈(P₁{P₀})∪P₂ broadcasts [symbol] PREVOTE,h,0,H(v) [symbol] to all participants and sets step=prevote. Each participant Pⱼ∈P₁∪P₂ receives 2t+1 messages [symbol] PREVOTE,h,0,H(v) [symbol] . The participant Pⱼ∈(P₁{P₀})∪P₂ sets lockedV=v, lockedR=0, step=precommit, validV=v, validR=0, and broadcasts [symbol] PRECOMMIT,h,0,H(v) [symbol] . Since each participant receives at most 2t pre-commit messages for the value v, no decision will be made during the round 0. A similar argument as in the Attack 1 can be used to show that the protocol will enter a deadlock. Please note in this Attack 3, participant Pⱼ in P₃ has received at most 2t prevote messages for the value v in round 0, which is still insufficient for P₁ to accept a proposal for a locked value v from other participants.

5 Casper FFG

Buterin and Griffith [4] proposed the BFT protocol Casper the Friendly Finality Gadget (Casper FFG) as an overlay atop a block proposal mechanism. In Casper FFG, weighted participants validate and finalize blocks that are proposed by an existing proof of work chain or other mechanisms. To simplify our discussion, we assume that there are n=3t+1 validators of equal weight. The Casper FFG works on the checkpoint tree that only contains blocks of height 100*k in the underlying block tree. Each validator Pⱼ can broadcast a signed vote (Pᵢ:s,t) where s and t are two checkpoints and s is an ancestor of t on the checkpoint tree. For two checkpoints a and b, we say that a→b is a supermajority link if there are at least 2t+1 votes for the pair. A checkpoint a is justified if there are supermajority links a₀→a₁→ . . . →a where a₀ is the root. A checkpoint a is finalized if there are supermajority links a₀→a₁→ . . . →aᵢ→a where a₀ is the root and a is the direct son of aᵢ. In Casper FFG, an honest validator Pᵢ should not publish two distinct votes

[symbol]

Pᵢ:s_{1,}t₁ [symbol] AND [symbol] Pᵢ:s_{2,}t₂

[symbol]

such that either

h(t₁)=h(t₂) OR h(s₁)<h(s₂)<h(t₂)<h(t₁)

here h(⋅) denotes the height of the node on the checkpoint tree. Otherwise, the validator's deposit will be slashed. Casper FFG is proved to achieve accountable safety and plausible liveness in [4] where
1. achieve accountable safety means that two conflicting checkpoints cannot both be finalized (assuming that there are at most t malicious validators), and
2. plausible liveness means that supermajority links can always be added to produce new finalized checkpoints, provided there exist children extending the finalized chain.

In order to achieve the liveness property, [4] proposed to use the “correct by construction” fork choice rule: the underlying block proposal mechanism should “follow the chain containing the justified checkpoint of the greatest height”.

The authors in [4] proposed to defeat the long-range revision attacks by a fork choice rule to never revert a finalized block, as well as an expectation that each client will “log on” and gain a complete up-to-date view of the chain at some regular frequency (e.g., once per month). In order to defeat the catastrophic crashes where more than t validators crash-fail at the same time (i.e., they are no longer connected to the network due to a network partition, computer failure, or the validators themselves are malicious), the authors in [4] proposed to slowly drains the deposit of any validator that does not vote for checkpoints, until eventually its deposit sizes decrease low enough that the validators who are voting are a supermajority. Related mechanism to recover from related scenarios such as network partition is considered an open problem in [4].

No specific network model is provided in [4]. Thus it is important to investigate the security of Casper FFG in various network models. The specification in [4] does not have sufficient details to guarantee its claimed plausible liveness. The authors mentioned that the Casper FFG could be used on top of most proof of work chains. However, without further restrictions on the block generation mechanisms, Casper FFG can reach deadlock (so plausible liveness property will not be satisfied). Assume that, at time T, the checkpoint a is finalized (where there is a supermajority link from a to its direct child b) and no vote for b's descendant checkpoint has been broadcast by any validator yet. Now assume that the underlying block production mechanism produced a fork starting from b. That is, b has two descendant checkpoints c and d. If t honest validators vote for c, t+1 honest validators vote for d, and t malicious validators vote randomly, then we reach a deadlock (since no link from b to its descendant can have a supermajority). If the checkpoints are 100 blocks away from each other and if it is expensive/slow to generate blocks (e.g., using proof of work (PoW)) then this kind of fork may be hard to happen though there is still a possibility.

6 Another Finality Gadget: Polkadot's GRANDPA

Based on the Casper FFG protocol, the project Polkadot (https://wiki.polkadot.network/) proposed a new BFT finality gadget protocol GRANDPA [11]. Specifically, Polkadot implements a nominated proof-of-stake (NPoS) system. At certain time period, the system elects a group of validators to serve for block production and the finality gadget. Nominators also stake their tokens as a guarantee of good behavior, and this stake gets slashed whenever their nominated validators deviate from their protocol. On the other hand, nominators also get paid when their nominated validators play by the rules. Elected validators get equal voting power in the consensus protocol. Polkadot uses BABE as its block production mechanism and GRANDPA as its BFT finality gadget. Here we are interested in the finality gadget GRANDPA (GHOST-based Recursive ANcestor Deriving Prefix Agreement) that is implemented for the Polkadot relay chain. GRANDPA contain two protocols, the first protocol works in partially synchronous networks and tolerates ⅓ Byzantine participants. The second protocol works in full asynchronous networks (requiring a common random coin) and tolerates ⅕ Byzantine participants. In contrast to Casper FFG, GRANDPA voters can cast votes simultaneously for blocks at different heights and GRANDPA only depends on finalized blocks to affect the fork-choice rule of the underlying block production mechanism.

The first GRANDPA protocol assumes that after an unknown time GST, the network becomes synchronous. However, it also assumes that all messages are delivered before time GST+Δ for some given value Δ. That is, no message gets lost. This network model is equivalent to our Type I asynchronous network and will not tolerate DoS attacks and network partition attacks. In the following paragraphs, we will show that GRANDPA is not even secure in the synchronous network.

Assume that there are n=3t+1 participants P₀, . . . , Pₙ₋₁ and at most t of them are malicious. Each participant stores a tree of blocks produced by the block production mechanism with the genesis block as the root. A participant can vote for a block on the tree by digitally signing it. For a set S of votes, a participant Pᵢ equivocates in S if Pᵢ has more than one vote in S. S is called tolerant if at most t participants equivocate in S. A vote set S has supermajority for a block B if

|{Pⱼ:Pᵢ votes for B*}∪{Pᵢ:Pᵢ eguivocates}|≥2t+1

where Pᵢ votes for B* mean that Pᵢ votes for B or votes for a descendant of B. The ⅔-GHOST function g(S) returns the block B of the maximal height such that S has a supermajority for B. If a tolerant vote set S has a supermajority for a block B, then there are at least t+1 voters who do vote for B or its descendant but do not equivocate. Based on this observation, it is easy to check that if s⊆T and T is tolerant, then g(S) is an ancestor of g(T).

The authors in [11] defined the following concept of possibility fora vote set to have a supermajority for a block: “We say that it is impossible for a set S to have a supermajority for a block B if at least 2t+1 voters either equivocate or vote for blocks who are not descendant of B. Otherwise it is possible for S to have a supermajority for B.” Then the authors [11] claimed that “a vote set S is possible to have a supermajority for a block B if and only if there exists a tolerant vote set T⊇S such that T has a supermajority for B”. However, this claim has semantic issues in practice. For example, assume that blocks B and C are inconsistent and the vote set S contains the following votes:

1. t malicious voters vote for B, one honest voter votes for B.

2. 2t honest voters vote for C.

By the definition of [11], S is not impossible to have a supermajority for B. Thus S is possible to have a supermajority for a block B. Since honest voters will not equivocate, there does not exist a semantically valid tolerant vote set T⊇S such that T has a supermajority for B. This observation could easily be used to show that the GRANDPA protocol cannot achieve the liveness property (see our discussion in next paragraphs).

6.1 GRANDPA Protocol

The GRANDPA protocol starts from round 1. For each round, one participant is designated as the primary and all participants know who is the primary. Each round consists of two phases: prevote and precommit. Let V_{r,i} and C_{r,i} be the sets of prevotes and precommits received by Pᵢ during round r respectively. Let E_{0,i} be the genesis block and E_{r,i} be the last ancestor block of g(V_{r,i}) that is possible for C_{r,i} to have a supermajority. If either E_{r,i}<g(V_{r,i}) or it is impossible for C_{r,i} to have a supermajority for any children of g(V_{r,i}), then we say that Pᵢ sees that round r is completable. Let Δ be a time bound such that it suffices to send messages and gossip them to everyone. The protocol proceeds as follows.
1. Pᵢ starts round r>1 if round r−1 is completable and Pᵢ has cast votes in all previous rounds. Let t_{r,i} be the time Pᵢ starts round r.
2. If Pᵢ is the primary of round r and has not finalized E_{r-1,i}, then it broadcasts E_{r-1,i}.
3. Pᵢ waits until either it is at least time tᵣ,i+2Δ or round r is completable. Pᵢ prevotes for the head of the best chain containing E_{r-1,i} unless Pᵢ receives a block B from the primary with g(V_{r-1,i})≥B>E_{r-1,i}. In this case, Pᵢ uses the best chain containing B.
4. Pᵢ waits until g(V_{r,i})≥E_{r-1,i} and one of the following conditions holds
   (a) it is at least time t_{r,i}+4Δ
   (b) round r is completable
(c) it is impossible for V_{r,i} to have a supermajority for any child of g(V_{r,i}) (this is an optional condition) Then Pᵢ broadcasts a precommit for g(V_{r,i})

At any time after the precommit step of round r, if Pᵢ sees that B=g(C_{r,i}) is descendant of the last finalized block and V_{r,i} has a supermajority, then Pᵢ finalizes B.

6.2 Attacks on GRANDPA Protocol

In this section, we show that GRANDPA protocol cannot achieve the liveness property even in the synchronous networks. Assume that E_{r-1,0}= . . . =E_{r-1,n-1}. During round r, the block production mechanisms produced a fork for E_{r-1,0}. That is, two child blocks B and C of E_{r-1,0} are produced. At round r, t+1 voters (including all malicious voters) prevote for B and the remaining honest 2t voters prevote for C. For each voter Pᵢ, we have g(V_{r,i})=E_{r-1,i}. Thus each Pᵢ precommits g(V_{r,i})=E_{r-1,i}. Now each voter Pᵢ estimates E_{r,i}=g(V_{r, i})=E_{r-1,i}. Since it is possible for C_{r,i} to have a supermajority for any child of E_{r,i}, the round r is not completable. That is, the process stuck at round r forever.

Even if one can revise the “possible” definition in the GRANDPA to resolve the issues that we have discussed in the preceding paragraph, our attacks on Tendermint could be easily mounted against GRANDPA protocol also. Thus GRANDPA protocol could not be secure in Type II networks.

7 A Secure BFT protocol in Type II Partial Synchronous Networks

In this section, we propose a Byzantine Agreement Protocol that achieves safety and liveness properties in Type II partial synchronous networks. Though our protocol could be used in other scenarios such as State Machine Replication (SMR), we present the protocol as a finality gadget for blockchains. Assume that there is a separate block proposal mechanism that produces children blocks for finalized blocks by our BFT finality gadget. Let B⁰, . . . , B^{h-1} be the blockchain where B⁰ is the genesis block and B^{h-1} is the most recently finalized head block. The block proposal mechanism may produce several child blocks B₀^{h}, B₁^{h}, . . . , Bₙ_{₀}₋₁^{h} of the current head block B^{h-1}. These child blocks are strictly ordered. For example, in proof of stake blockchain applications, each participant has a stake value for the chain height h and these child blocks may be ordered using proposer's stake values. However, it is beyond the scope of the subject matter described herein to specify how these child blocks are ordered for general blockchains. It is the task for the BFT finality gadget to select the maximal block among these candidate child blocks as the next block B^{h}. Though the goal of the BFT protocol is to select the maximal child block as the final version of block B^{h}, this may not be true in certain scenarios. For example, if t+1 honest participants have seen the child block Bₙ_{₀}₋₂^{h} and have not seen the maximal block Bₙ_{₀}₋₁^{h} at the start of the protocol (at the same time, we may assume that the other t honest participants have seen the maximal block Bₙ_{₀}₋₁^{h}), then our BFT protocol BDLS will finalize Bₙ_{₀}₋₂^{h} instead of Bₙ_{₀}₋₁^{h} (assuming that the t malicious participants submit the block Bₙ_{₀}₋₂^{h} to the leader). Secondly, our BFT protocol leverages the fact that a candidate block is self-certified. That is, the validity of a candidate child block can be verified by using the information contained in the candidate block itself against the currently finalized blockchain.

7.1 The BFT Protocol (BDLS)

Our BFT protocol is based on the original DLS protocol in Dwork, Lynch, and Stockmeyer [9] and we call it a Blockchain version of DLS (BDLS). For each blockchain height h, BDLS protocol runs from round to round until it reaches an agreement for the height h. Then the protocol moves to the next blockchain height h+1. Let P₀, . . . , Pₙ₋₁ be the n=3t+1 participants of the protocol. Assume that there are ₙ_{₀} valid candidate proposals B₀^{h}<B₁^{h}< . . . <Bₙ_{₀}₋₁^{h} for the block B^{h}. During the protocol run, each participant Pᵢ maintains a local variable BLOCKᵢ⊆{B₀^{h},B₁^{h}, . . . ,Bₙ_{₀}₋₁^{h}} that contains the candidate blocks that it has learned so far. Participant Pᵢ prefers the maximal block in BLOCK to be selected as the final block for B^{h}. The goal of the BDLS protocol is for participants P₀, . . . , Pₙ₋₁ to reach a consensus on the finalized block B^{h}.

Generally, we can use a robust threshold signature scheme to reduce the authenticator complexity, e.g., achieve linear authenticator complexity. For simplicity, the following protocol description is based on a standard digital signature scheme. It could be easily revised to use a threshold signature scheme. Following Dwork, Lynch, and Stockmeyer [9], we assume that all messages after the unknown global stabilization time (GST) will be delivered in the same round and messages before round GST could get lost or re-ordered. Furthermore, though all participants have a common numbering for the round, they do not know when the round GST occurs. A candidate block B′ is acceptable to Pᵢ if Pᵢ does not have a lock on any value except possibly B′. There is a public function leader(h,r) that returns the round leader for a given round r of the height h. For each height h, the BDLS protocol proceeds from round to round (starting from round 0) until the participant decides on a value. The round r of the height h starts when at least 2t+1 participants submit a round-change message to the leader participant. The round r proceeds as follows where Pᵢ=leader(h,r) is the leader for round r:
1. Each participant Pⱼ (including Pᵢ) sends the signed message (<h,r>ⱼ,<h,r,Bⱼ′>ⱼ) to the leader Pᵢ where Bⱼ′ ∈BLOCKⱼ is the maximal acceptable candidate block for Pⱼ. The message <h,r>ⱼ is considered as a round-change message. After sending the round-change message, Pⱼ will not accept messages except a “decide” message for round r′<r anymore.
2. If Pᵢ receives at least 2t+1 round-change messages (including himself), it enters round r (see Section 7.4 for details on when Pᵢ can stop waiting for more round-change request messages). In these round-change messages, if there are at least 2t+1 signed messages from 2t+1 participants with the same candidate block B′≠NULL, then Pᵢ broadcasts the following signed message (2) to all participants

[symbol]

lock,h,r,B′,proof [symbol] ᵢ (2)
where proof is a list of at least 2t+1 signed messages showing that B′ is the candidate blocks for at least 2t+1 participants (the proof also shows that round-change request has been authorized by at least 2t+1 participants). If Pᵢ does not receive such a block B′, then Pᵢ adds all received candidate blocks to its local variable BLOCKᵢ and broadcasts [symbol] select,h,r,B″,proof [symbol] where B″ is the candidate block B″=max{B:B∈BLOCKᵢ} and proof is a list of at least 2t+1 round-change messages. In some embodiments, e.g., to achieve linear communication complexity when a threshold signature scheme employed, the “proof” in the lock-message and select-message may be different: In the lock-message, the “proof” contains an assembled digital signature on the message [symbol] h,r,B′ [symbol] while, in the select-message, the “proof” contains an assembled digital signature on the message [symbol] h,r [symbol] . See Remark 3 for details.
3. If a participant Pⱼ (including Pᵢ) receives a valid [symbol] select,h,r,B″,proof [symbol] from Pᵢ during Step 2, then it adds B″ to its BLOCKⱼ. If a participant Pⱼ (including Pᵢ) receives a valid message [symbol] lock,h,r,B′r,proof [symbol] ⱼ from Pᵢ in Step 2, then it does the following:
   (a) releases any potential lock on B′ from previous round, but does not release locks on any other potential candidate blocks
   (b) locks the candidate block B′ by recording the valid lock (2)
   (c) sends the following signed commit message to the leader Pᵢ.

[symbol]

commit,h,r,B′ [symbol] ⱼ. (3)
4. If Pᵢ receives at least 2t+1 commit messages (3), then Pᵢ decides on the value B′ and broadcasts the following decide message to all participants

[symbol]

decide,h,r,B′,proof)ᵢ. (4)
where proof is a list of at least 2t+1 commit messages (3).
5. If a participant Pⱼ (including Pᵢ) receives a decide message (4) from Step 4 or from its neighbor, Pⱼ decides on the block B′ for B^{h} and moves to the next height h+1 (that is, run the Step 1 of height h+1 by sending the round-change message). At the same time, the participant Pⱼ propagates (broadcasts) the decide message (4) to all of its neighbors if it has not done so yet (see the following Remark 2 for more details on this). Otherwise, it goes to the following lock release step:
   (lock release) If a participant Pⱼ (including Pᵢ) has some locked values, it broadcasts all of its locked values with proofs. A participant releases its lock on a value [symbol] lock,h,r″,B″,proof [symbol] _{i″} if it receives a lock [symbol] lock,h,r′,B′,proof [symbol] _{i′} with r′≥r″ and B′≠B″.
   Move to the next round r+1 (e.g., run the Step 1 of height h with r+1).
6. height synchronization: At any time during the protocol, if Pⱼ receives a finalized bock of height h (e.g., a decide message (4)), Pⱼ decides for height h and moves to height h+1.
7. round synchronization: At any time during the protocol, if P₁ receives a valid “lock” or “select” or “decide” message for a round r′>r, Pⱼ moves to round r′ and processes the “lock” or “select” or “decide” message.
8. timeout: For each step, Pⱼ should set an appropriate timeout counter. If Pⱼ does not receive enough messages to move forward before timeout counter expires, it moves to the next step. Section 7.4 and Section 8 includes additional details regarding round/height synchronization.

Remark 1: In the BDLS protocol, the lock release step is a mesh network broadcast. In some applications, one may prefer a star network to reduce the total number of messages from n² to n, e.g., to achieve linear communication complexity. One may achieve this kind of needs by replacing the “lock release” step with the following additions to the protocol. At the Step 1 of round r, each participant P₁ sends the message

all-locked-values, [symbol] h,r,Bⱼ′ [symbol] ⱼ

instead of only sending the message [symbol] h,r,Bⱼ′ [symbol] ⱼ to Pᵢ, where “all-locked-values” is the set of candidate blocks that Pⱼ has locks on. During Step 2, if Pᵢ cannot lock a candidate block during round r, then it broadcasts the candidate block B″=max{B:B∈BLOCKᵢ} together with all locked candidate blocks by all participants. It is straightforward to check that our security analysis in the next section remains unchanged for this protocol revision.

Remark 2: During Step 5 of the BDLS protocol, when a participant receives a decide message, it propagates/broadcasts the decide message to its neighbors. It is recommended that each participant keep broadcasting the signed decide message for height h regularly until it receives at least 2t broadcasts of the decide message for height h from other 2t participants. The importance of this propagation/broadcast is illustrated in Section 9.

Remark 3: To achieve linear communication/authenticator complexity with threshold digital signature schemes, participant 13 may send the signed message ( [symbol] h,r, [symbol] ⱼ [symbol] h,r,Bⱼ′ [symbol] ⱼ) to the leader Pᵢ during step 1. It should be noted that if there are 2t+1 participants that send the same Bⱼ′ to the leader, then the leader Pᵢ can assembly a signature for [symbol] h,r,Bⱼ′ [symbol] . If there is no such value Bⱼ′, then the leader can only assembly a digital signature for [symbol] h,r, [symbol] which can be used for the select message. In the security proof for BDLS in the next section, the leader does not need to assemble a digital signature for Bⱼ′ if it only broadcasts a select message.

7.2 Liveness and Safety

The security of BDLS protocol is proved by establishing a series of Lemmas. The proofs for Lemmas 7.1, 7.2, 7.3 and Theorem 7.4 follow from straightforward modifications of the corresponding Lemmas/Theorem in [9]. For completeness, we include these proofs here also.

Lemma 7.1 It is impossible for two candidate blocks B′ and B″ to get locked in the same round r of height h.

Proof. In order for two blocks B′ and B″ to get locked in one round r of height h, the leader Pᵢ=leader(h,r) must send two conflict lock messages (2) with different proofs. This can only happen if there exist at least t+1 participants Pⱼ each of whom equivocates two messages [symbol] h,r,B′ [symbol] ⱼ and [symbol] h,r,B″ [symbol] ⱼ to Pᵢ. This is impossible since there are at most t malicious participants.

Lemma 7.2 If the leader Pᵢ decides a block value B′ at round r of height h and r is the smallest round at which a decision is made. Then at least t+1 honest participants lock the candidate block B′ at round r. Furthermore, each of the honest participants that locks B′ at round r will always have a lock on B′ for round r′≥r.

Proof. In order for Pᵢ to decide on B′, at least 2t+1 participants send commit messages (3) to Pᵢ at round r of height h. Thus at least t+1 honest participants have locks on B′ at round r. Assume that the second conclusion is false. Let r′>r be the first round that the lock on B′ is released. In this case, the lock is released during the lock release step of round r′ if some participant has a lock on another block B″≠B′ with associated round r″ where r′≥r″≥r. Lemma 7.1 shows that it is impossible for a participant to have a lock on B″ in round r. Thus the participant acquired the lock on B″ in round r″ with r′≥r″>r. This implies that, at the step 1 of round r″, more than 2t+1 participants send signed messages (h,r″,B″) to the leader participant. That is, at least 2t+1 participants have not locked B′ at the step 1 of round r″. This contradicts the fact that at least t+1 participants have locked B′ at the start of round r″.

Lemma 7.3 Immediately after any lock release step at or after the round GST, the set of candidate blocks locked by honest participants contains at most one value.

Proof. This follows from the lock release step.

Theorem 7.4 (Safety) Assume that there are at most t malicious participants. It is impossible for two participants to decide on different block values.

Proof. Suppose that an honest participant Pᵢ decides on B at round r and this is the smallest round at which the decision is made. Lemma 7.2 implies that at least t+1 participants will lock B′ in all future rounds. Consequently, no other block values other than B′ will be acceptable to 2t+1 participants. Thus no participants will decide on any other values than B′.

Theorem 7.5 (Liveness) Assume that there are at most t malicious participants and valid candidate child blocks for B^{h} are always produced by the block proposal mechanism before the start of first round for height h for all h. Then BDLS protocol will finalize blocks for each height h. That is, the BDLS protocol will not reach a deadlock.

Proof. We consider two cases. For the first case, assume that no decision has been made by any honest participants and no honest participant locks a candidate block at round r where r≥GST is the first round after GST that the leader participant is honest. In this case, if Pᵢ receives 2t+1 signed messages for a candidate block B′ in step 1 of round r, then all honest participants will decides on B′ by the end of round r. Otherwise, Pᵢ broadcasts the maximal candidate block B″ during step 2 of round r. Thus all honest participants will receive this maximum block and this candidate becomes the maximum acceptable candidate block for all honest participants. Then, in round r′>r where r′ is the smallest round after r that the leader participant is honest, all honest participants decide on a maximal block.

For the second case, assume that no candidate block is locked at the start of round GST and some participants hold a lock on a candidate block B′. By Lemma 7.3, there are at most one value locked by honest participants at the end of round GST. Furthermore, at the end of round GST, all the honest participants either decide on B′ or obtain a lock on B′. Thus if no decision is made during round GST, the decision will be made during round GST+1.

7.3 Complexity Analysis

In this section, we compare the performance of PBFT, Tendermint BFT, HotStuff BFT and our BDLS protocols. Three kinds of primitives are used in these protocol design: (1) broadcast from the leader to all participants; (2) all participants send messages to the leader; and (3) all participants broadcast. We use the following symbols to denote these primitives:

[symbol] : leader broadcasts

[symbol] : all participants send messages to the leader

[symbol] : all participants broadcast

In the following, we compare the performance of these protocols after the network is synchronized (that is, after GST) and when the round has an honest leader. For all of these protocols, they will reach agreement within one run of the protocol assuming all participants have all the necessary input values at the start of the protocol and the leader is honest.

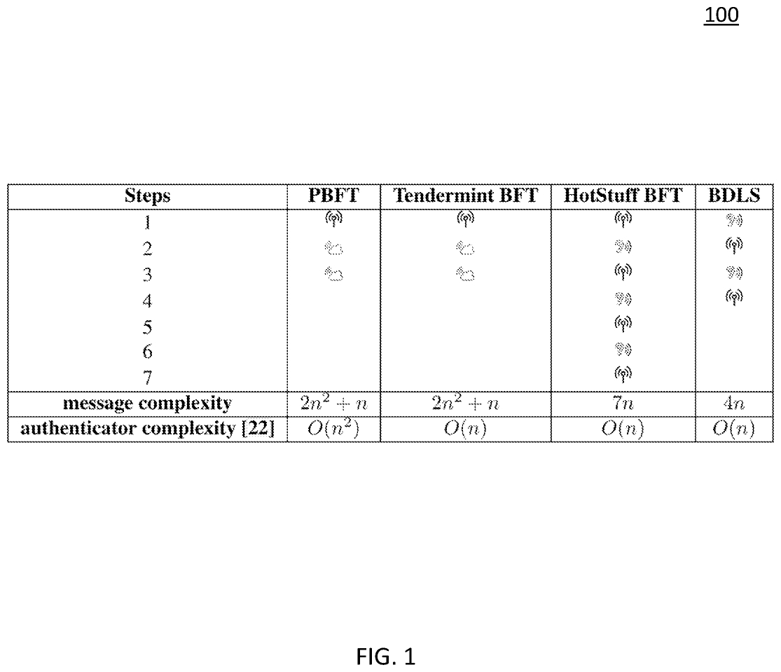

FIG. 1 depicts a table 100 containing information about different BFT protocols with a honest leader after GST. Table 100 indicates the steps of one run of these protocols. Furthermore, for BDLS, we use the approaches discussed in the Remarks after the BDLS protocol description to embed the lock release step into Steps 1 and 2. For each [symbol] or [symbol] step, there is a total of n messages communicated in the network. For each [symbol] step, there is a total of n² messages communicated in the network. The row “message complexity” of Table 100 indicates the total number of messages communicated in the network for each run of the protocol. That is, in the ideal synchronized network, this is the total number of messages that are needed to achieve a consensus. These numbers show that BDLS has the smallest number of messages for a consensus in the synchronized network. Another way to compare the performance of BFT protocols is to compare the number of authenticator operations (signing and verifying) that are needed to achieve a consensus (see, e.g., [20]). Assume that all these schemes (except PBFT) use threshold digital signature schemes, then the row “authenticator complexity” of Table 100 indicates the total number authenticator operations needed for each run of the protocol.

8 Implementation and Performance Evaluation

8.1 Chained BDLS and Other Implementation Related Issues

In order to improve efficiency, several blockchain BFT protocols (e.g., Ethereum Casper FFG, HotStuff BFT, and LibraBFT) adopt the chaining paradigm where the BFT protocol phases for commitment are spread across rounds. That is, every phase is carried out in a round and contains a new proposal. The same techniques could be used to construct a chained BDLS. As noted in HotStuff BFT and LibraBFT, the block tree in chained LibraBFT and chained HotStuff BFT may contain “chains” that have gaps in round numbers. Thus the commit logic for LibraBFT and HotStuff BFT requires a 3-chain with contiguous round numbers whose last descendant has been certified. Since BDLS is a 2-phase BFT protocol, chained BDLS “decide” logic requires a 2-chain with contiguous round numbers whose last descendant has been certified.

For chained BFT protocol implementation, the BFT protocol participants for various rounds/heights should be relatively static. If the BFT protocol participants change from rounds to rounds or from heights to heights, it is not realistic to implement chained BFT protocols. Thus chained BFT protocol implementation is suitable for permissioned blockchains such as Libra blockchain while it is not suitable for permissionless blockchains where BFT protocol participants change frequently. The same rule applies to threshold digital signature scheme implementation for BFT protocols. That is, for permissionless blockchains where BFT protocol participants change frequently, it may have limited advantage in using threshold digital signature schemes since the expensive key set-up process has to be run each time when the participants set changes.

In most distributed BFT protocols, when the participants could not reach an agreement in one round, participants move to a new round by submitting round-change request. Thus BFT participants may be in different status and receive different messages. It is important to maximize the period of time when at least 2t+1 honest participants are in the same round. PBFT protocol achieves round synchronization by exponentially increasing the timeout length for each round. That is, if the round 0 of height h has a timeout length of Δ, then the round r of height h will have a timeout length of 2r Δ. On the other hand, Tendermint BFT achieves round synchronization by linearly increasing the timeout length for each round. That is, the round r has a timeout length of rΔ where Δ is the timeout length for round 0 of height h. HotStuff proposes a functionality called PaceMaker to achieve round synchronization without details on how to implement the PaceMaker. LibraBFT implemented the PaceMaker functionality in the following way. When a participant gives up on a certain round r, it broadcasts a timeout message carrying a certificate for entering the round. This brings all honest participants to r within the transmission delay bound. When timeout messages are collected from a quorum of participants, they form a timeout certificate. BDLS may use any of these recommended approaches for round synchronization.

8.2 BDLS with Pacemaker Mechanism

Though BDLS may use a PBFT mechanism to keep round synchronization (that is, the timeout period for round r is 2r Δ), it may be more efficient to use a pacemaker or heartbeat mechanism for BDLS round synchronization. Similar to LibraBFT, the advancement of rounds in BDLS is governed by a module referred to herein as Pacemaker. Pacemaker keeps track of votes and of time. In some embodiments, BDLS may be modified to include Pacemaker so that Pacemaker can be seamlessly integrated into the protocol without extra workload. The major change is Step 1 where Pacemaker timeout messages are combined with round-change messages for efficiency. The round r of the height h for a participant Pⱼ starts when its Pacemaker receives round-change messages from at least 2t+1 participants or if its timeout for round r−1 or if it receives a “lock” or a “select” or a “decide” message for round r. Specifically, the round r proceeds as follows where Pᵢ=leader(h,r) is the leader for round r:
1. (If r>0, this step is done at the end of round r−1 of height h. If r=0, this step is done after a decision for height h−1 is made.) Pacemaker of each participant Pⱼ (including Pᵢ) broadcasts the signed message ( [symbol] h,r [symbol] ⱼ, [symbol] h,r,Bⱼ′ [symbol] ) where Bⱼ′∈BLOCK_{J} is the maximal acceptable candidate block for Pⱼ of height h. The message [symbol] h,r [symbol] ⱼ is considered as a round-change message for round r. After Pⱼ broadcasts the round-change message for round r, it will set a timeout message Δ₀ and enters round-changing status. During round-changing status, a participant will not accept any messages except round-change messages and “decide” messages for the height h of any round. Furthermore, if r>0, then each participant Pⱼ (including Pᵢ) initializes all of its variables except the locked block variable. If r=0, then each participant Pⱼ (including Pᵢ) initializes all of its variables including the locked block variable. For any participant Pⱼ who is in round-changing status, if it does not enter the lock status of Step 2 before Δ₀ expires, it resends the round-change message and resets its Δ₀.
2. During any time of the protocol, if Pacemaker of Pⱼ (including Pᵢ) receives at least 2t+1 round-change messages (including a round-change message from himself) for round r (which is larger than its current round status), it enters lock status of round r. If Pⱼ has not broadcast the round-change message yet, it broadcasts now. Then Pⱼ sets the timeout counter Δ₁ for lock status. The lock status timeout counter can be set as follows. For round r=0, the timeout counter Δ₁=Δ_{1,0} may be at least four network transmission delays plus some time for each participant to process the messages. For round r>0, the timeout counter may be defined as rΔ_{1,0}. Furthermore, as soon as the leader Pᵢ enters Δ₁′<Δ₁ concurrently. Though it is sufficient for a non-leader participant to collect only 2t+1 round-change requests, the leader may collect as many round-change message as possible. In particular, the leader should try to collect all round-change messages from all participants. It is recommended that after the leader Pᵢ collects 2t+1 round-change requests and starts the lock status timeout counter Δ₁, it initiates another timeout counter Δ₁′<Δ₁ to collect as many as possible round-change requests if more round-change requests still arrive. Generally, we can set Δ₁ as two network transmission delays. This mechanism is used to avoid the following attack: the malicious t participants may send random round-change messages to the leader. If the leader only checks the first 2t+1 messages (among them, t could be malicious), then the system may never reach an agreement. However, the leader should not wait forever since the t malicious participants may choose not to send round-change request at all. The leader Pᵢ stops the time counter Δ₁′, Pᵢ distinguishes the two cases:
   (a) Among all round-change messages that Pᵢ has received, if there are at least 2t+1 signed messages from 2t+1 participants with the same candidate block B′≠NULL, then Pᵢ broadcasts the following signed message (2) to all participants

[symbol]

lock,h,r,B′,proof [symbol] ᵢ (5)
where the proof shows that at least 2t+1 participants signed messages indicating that B′ is the candidate block (the proof also shows that a round-change request has been authorized by at least 2t+1 participants).
(b) If Pᵢ does not receive such a block B′, then Pᵢ adds all received candidate blocks to its local variable BLOCK, and broadcasts

[symbol]

select,h,r,B″,proof [symbol] (6)
where B″ is the candidate block B″=max{B:B∈BLOCKᵢ} and the proof shows that round-change requests have been authorized by at least 2t+1 participant from Step 1.
3. If a participant Pⱼ (including Pᵢ) does not receive a valid message from the leader Pᵢ during Step 2 and the timeout counter Δ₁ expires, Pⱼ enters commit status of round r and sets the timeout counter Δ₂ for commit status. The commit status timeout counter can be set as follow. For round r=0, the timeout counter Δ₂=Δ_{2,0} may be at least two network transmission delays plus some time for each participant to process the messages. For round r>0, the timeout counter may be defined as rΔ_{2,0}. Otherwise, if a participant Pⱼ (including Pᵢ) receives a valid message (5) or (6) from Pᵢ before Δ₁ expires, Pⱼ stops the time counter Δ₁ and distinguishes the following two cases:
   If Pⱼ receives a valid [symbol] select,h,r,B″,proof [symbol] from Pᵢ during Step 2, then it adds B″ to its BLOCKⱼ and enters lock release status of round r and sets the timeout counter Δ₃ for lock-release status.
   If Pⱼ (including Pᵢ) receives a valid message [symbol] lock,h,r,B′,proof [symbol] ᵢ from Pᵢ in Step 2, then it does the following and enters commit status by setting the timeout counter Δ₂:
      (a) releases any potential lock on B′ from previous round, but does not release locks on any other potential candidate blocks
      (b) locks the candidate block B′ by recording the valid lock (5)
      (c) sends the following signed commit message to the leader Pᵢ.

[symbol]

commit,h,r,B′ [symbol] ⱼ (7)
4. If Pᵢ receives at least 2t+1 commit messages (7) for the round r of height h with the locked value B′ of (5) before Δ₂ expires, then Pᵢ decides on the value B′ and broadcasts the following decide message to all participants

[symbol]

decide,h,r,B′, proof [symbol] ᵢ (8)
where proof is a list of at least 2t+1 commit messages (7).
5. If a participant Pⱼ (including Pᵢ) receives a decide message (8) from Step 4 or from its neighbor before the timeout counter Δ₂ expires, it decides on the block B′ for B^{h} and the Pacemaker of Pⱼ goes to Step 1 of height h+1. At the same time, the participant Pⱼ propagates (broadcasts) the decide message (8) to all of its neighbors if it has not done so yet. Otherwise, if Pⱼ (including Pᵢ) does not receive a decide message from the leader Pᵢ or its neighbors before the timeout counter Δ₂ expires, Pⱼ enters lock release status of round r and sets the timeout counter Δ₃ for lock release status. The lock release status timeout counter can be set as follow. For round r=0, the timeout counter Δ₃=Δ_{3,0} may be at least two network transmission delays plus some time for each participant to process the messages. For round r>0, the timeout counter may be defined as rΔ_{3,0}.
6. (lock release) If a participant Pⱼ (including Pᵢ) has some locked values, then P₁ calculates

r₁=max{r′:Pⱼ holds a lock [symbol] lock,h,r′,B′,proof [symbol] _{i′}}.
Pⱼ releases all locks [symbol] lock,h,r″,B″,proof [symbol] ₁″ with r″≠r₁. Pⱼ then broadcasts the following lock release message

[symbol]

lock−release,h,r, [symbol] lock,h,r₁,B′,proof [symbol] ᵢ_{₁} [symbol] . (⁹)
If Pⱼ receives a lock release message (lock−release,h,r, [symbol] lock,h,r₁′, B″′,proof [symbol] ᵢ_{_{1′}} [symbol] with r_{1′}>r₁ from another participant before the timeout Δ₃ expires, then Pⱼ releases its lock [symbol] lock,h,r₁,B′,proof [symbol] ᵢ_{_{1′}} and records the lock [symbol] lock,h,r₁′,B″′,proof [symbol] ᵢ_{_{1′}}. After the timeout Δ₃ expires, Pacemaker of Pⱼ goes to Step 1 for round r+1 of height h.
7. height synchronization: At any time of the protocol run, if Pⱼ receives a finalized bock of height h (e.g., a decide message (8)), Pⱼ decides for height h and moves to height h+1.
8. round synchronization: At any time of the protocol run, if Pⱼ receives a valid “lock” or “select” or “decide” message for a round r′>r, Pⱼ moves to round r′ and process the “lock” or “select” or “decide” message. Furthermore, at any time, if Pⱼ receives from more than t+1 participants valid messages for round r′>r (including round-change messages for round r′), Pⱼ goes to Step 1 for round r′ of height h.

8.3 BFT Consensus Algorithm

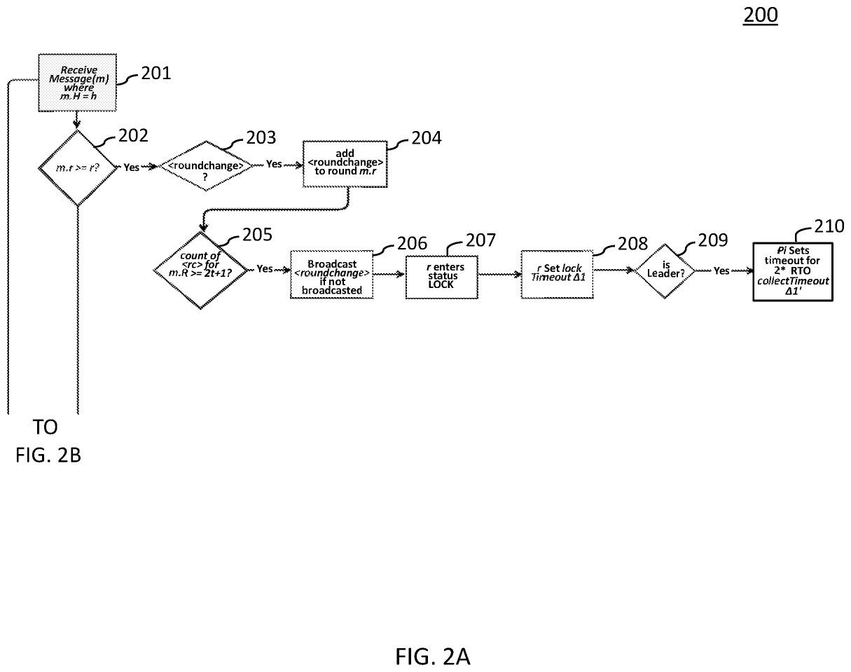

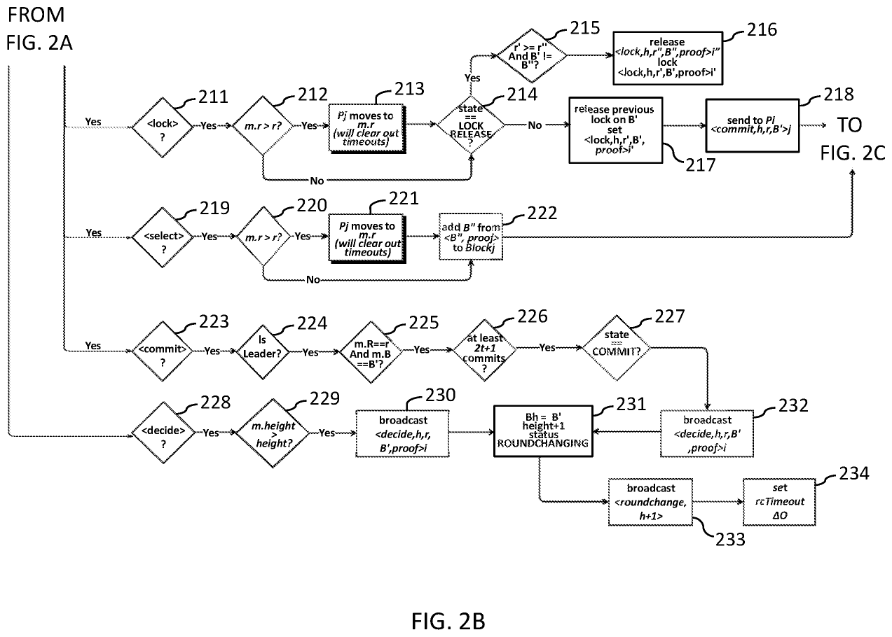

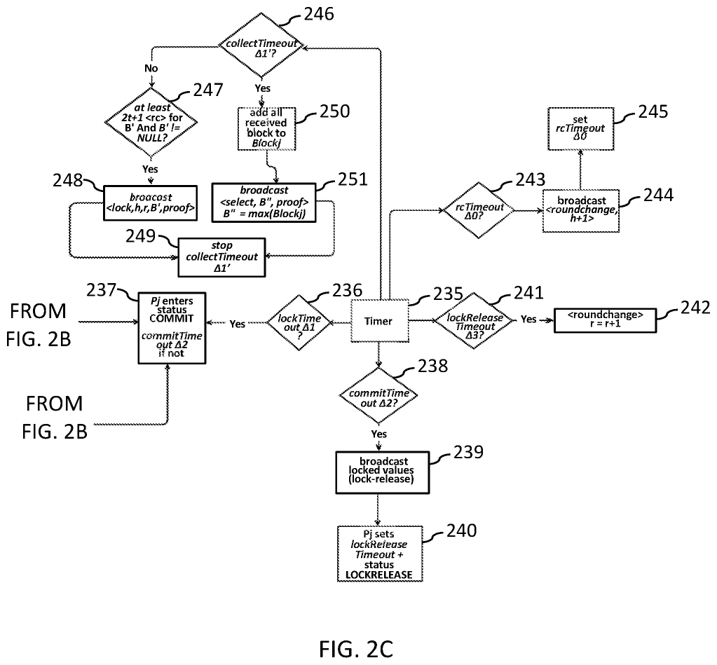

FIGS. 2A-2C depict portions of a block diagram illustrating a BFT consensus algorithm 200. In particular, FIGS. 2A-2C depicts various possible operations or actions associated with algorithm 200. For example, algorithm 200 or a variation thereof may be implemented by each participant for a given height in one or more rounds of consensus determinations.

Referring to FIG. 2A, in step 201, a message is received of a height h. If the receive message is a decide message, then step 228 occurs otherwise step 202 occurs. In step 202, when the receive message is not a decide message, it is determined whether the message round is greater than or equal to the current round of a participant and, if so, depending on what type of message is received, algorithm 200 may move to step 203, step 211, step 219, or step 223.

In step 203, it is determined whether the message is a round-change message. In step 204, if the message is a round-change message, the round-change message information is stored by the participant for the round indicated by the message. In step 205, it is determined whether the number of received round-change messages for the message round reaches or exceeds the predetermined number (e.g., 2t+1, where t is the number of malicious participants) of participants. In step 206, if the threshold is reached, the participant sends a round-change message if the participant has not already. In step 207, the participant enters a lock status for the round. In step 208, the participant sets a lock timeout timer, wherein if the lock status is removed if the timer runs out. In step 209, it is determined whether the participant is the current participant leader (for the round). If step 210, the current participant leader sets a collection timeout timer so that round-change messages can be received or collected (e.g., the timeout period may be based on round trip latency and/or other information).

Referring to FIG. 2B, in step 211, it is determined whether the message is a lock message. In step 212, if the message is a lock message, it is determined whether the message round is greater than the current round of a participant. If the message round is greater than the current round, step 213 occurs and if not then step 214 occurs. In step 213, the participant moves its current round to the message round including clearing all previous round timers and then step 214 occurs. In step 214, it is determined whether the participant is in a lock release state. If the participant is in the lock release state, step 215 occurs and if not step 217 occurs. In step 215, it is determined whether the current round is different from the round associated with the existing lock and the candidate block associated with the lock is different from the current candidate block. If so, in step 216, the existing lock is released and a new lock for the current round and candidate block is set. In step 217, the existing lock is release and a new lock for the current round and candidate block is set. In step 218, the participant sends a commit message indicating the candidate block to the current participant leader and then enters a commit status and starts a commit timeout timer (step 237 shown in FIG. 2C).

In step 219, it is determined whether the message is a select message. In step 220, if the message is a select message, it is determined whether the message round is greater than the current round of a participant. If the message round is greater than the current round, step 221 occurs and if not then step 222 occurs. In step 221, the participant moves its current round to the message round including clearing all previous round timers and then step 222 occurs. In step 222, the participant stores the candidate block from the select message as its candidate block and enters a commit status and starts a commit timeout timer (step 237 shown in FIG. 2C).

In step 223, it is determined whether the message is a commit message. In step 224, if the message is a commit message, it may be determined whether the participant is the current participant leader (for the round). If step 225, the current participant leader determines whether the current round is the same as the round in the commit message and the current candidate block is the same as the candidate block in the commit message. If so, in step 226, the current participant leader determines whether commit messages from at least 2t+1 participants. If so, in step 227, the current participant leader enters a commit status and broadcasts a decide message indicating the candidate block to other participants (step 232) and the current participant leader increments its current height by one (from the height indicated in the decide message), and then enters a round changing status.

In step 228, it may be determined whether a received message is a decide message , In step 229, if the message is a decide message, it may be determined whether the height in the message is the greater than the current height stored at the participant. If so, in step 230, the participant broadcasts the decide message to other participants. In step 231, the participant decides on the candidate block for the height indicated in the decide message and increments its current height by one (from the height indicated in the decide message), and then enters a round changing status.

After entering a round changing status, in step 233, the participant broadcasts a round-change message indicating the current (new) height and sets a round-change timeout timer (step 234), where the round-change status expires at the end of the timer.

Referring to FIG. 2C, timer related actions associated with algorithm 200 are depicted. In step 235, a particular timer for a participant is started. In step 236, if the timer is a lock timeout timer and it expires, then the participant enters a commit status and starts a commit timeout timer (step 237). In step 238, if the timer is a commit timeout timer and it expires, then the participant broadcasts a lock release message (step 239). In step 240, the participant enters a lock release status and sets a lock release timeout timer.

In step 241, if the timer is a lock release timeout timer and it expires, then the participant broadcasts a round-change message indicating a new round (e.g., increments the current round by 1) (step 242).

In step 243, if the timer is a round-change timeout timer and it expires, then the participant broadcasts a round-change message indicating a new height (e.g., increments the current height by 1) (step 244). In step 245, the participant sets a new round-change timeout timer.

In step 246, if the timer is a collect timeout timer, then before it expires, it is determined whether the participant has received round-change messages from at least 2t+1 participants, and that these messages indicate the same candidate block B′ and B′ is not NULL (step 247). If so, in step 248, the participant broadcasts a lock message to other participants, where the lock message indicates that round-change messages indicating a same candidate block have been received from a at least 2t+1 participants and, after broadcasting the lock message, the participant stops the collect timeout timer (step 249).

In step 246, if the timer is a collect timeout timer and it expires, the participant adds all received candidate blocks to its local variable BLOCKⱼ (step 250). In step 251, the participant broadcasts a lock message to other participants, where the lock message indicates the maximal candidate block from the received candidate blocks and, after broadcasting the lock message, the participant stops the collect timeout timer (step 249).

It will be appreciated that algorithm 200 is for illustrative purposes and that different and/or additional actions may be used. It will also be appreciated that various actions described above with regard to algorithm 200 may occur in a different order or sequence.

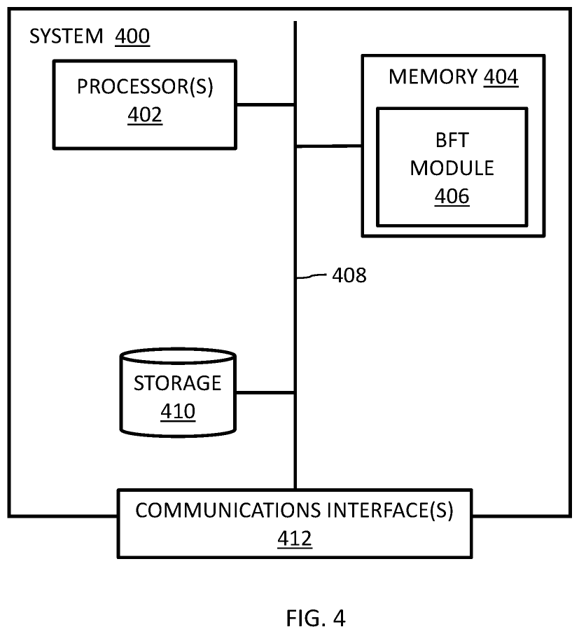

FIG. 4 is a diagram illustrating an example computer system 400 for providing BFT. In some embodiments, computer system 400 may be a single device or node or may be distributed across multiple devices or nodes.

Referring to FIG. 4, computer system 400 includes one or more processor(s) 402, a memory 404, and storage 410 communicatively connected via a system bus 408. Computer system 400 may represent one or more computing platforms or devices. Computer system 400 may include or utilize one or more communications interface(s) 412. In some embodiments, processor(s) 402 can include a microprocessor, a central processing unit (CPU), a graphics processing unit (GPU), and/or any other like hardware based processing unit. In some embodiments, a BFT module 406 can be stored in memory 404, which can include random access memory (RAM), read only memory (ROM), optical read/write memory, cache memory, magnetic read/write memory, flash memory, or any other non-transitory computer readable medium.

BFT module 406 may include logic and/or software for performing various functions and/or operations described herein. In some embodiments,

BFT module 406 may include or utilize processor(s) 402 or other hardware to execute software and/or logic. For example, BFT module 406 may perform various functions and/or operations associated with providing BFT and/or related operations. In this example, BFT module 406 may be used in various applications, e.g., a consensus application, a blockchain application, a distributed computing application, and/or an authentication application.

In some embodiments, computer system 400 may include one or more communications interface(s) 412 for communicating with nodes, modules, and/or other entities. For example, one or more communications interface(s) 112 may be used for communications between BFT module 406 and a system operator and a same or different communications interface for communicating with other modules or network nodes.

In some embodiments, processor(s) 402 and memory 404 can be used to execute BFT module 406. In some embodiments, storage 410 can include any storage medium, storage device, or storage unit that is configured to store data accessible by processor(s) 402 via system bus 408. In some embodiments, storage 410 can include one or more databases hosted by or accessible by computer system 400.

In some embodiments, BFT module 406 may perform a method and/or technique (e.g., algorithm 200 or a variation thereof) for providing BFT in an asynchronous (e.g., partially synchronous) environment. For example, BFT module 406 may perform algorithm or a variation of BDLS described herein. In this example, BFT module 406 may perform different actions based on different types of signed messages, current states, and/or various timers when reaching a consensus decision or related functionality.

In some embodiments, BFT module 406 may be associated with participants performing a distributed computing application, e.g., blockchain generation or digital currency mining. In such embodiments, BFT module 405 may utilize algorithm 200 or a similar algorithm to determine a candidate block for a given height and round. For example, computer system 400 may utilize BFT module 406 to execute a BFT protocol, wherein computer system 400 acts as a leader participant of a round in a consensus decision. In this example, computer system 400 or BFT module 406 may receive signed round-change messages from multiple participants in the round; broadcast (e.g., send to multiple participants) a signed lock message indicating that signed round-change messages have been received from a predetermined number of participants (e.g., at least 2t+1 participants, where t represents an amount of malicious participants in the round) indicating a same candidate block (e.g., ); receiving signed commit messages from multiple participants in the round; and broadcasting a signed decide message indicating the candidate block is a finalized block (e.g., after a predetermined number of participants in the round have sent signed commit messages indicating the candidate block).

It will be appreciated that FIG. 4 is for illustrative purposes and that various nodes, their locations, and/or their functions may be changed, altered, added, or removed. For example, some nodes and/or functions may be combined into a single entity or some functionality (e.g., BFT module 406 and a pacemaker module and/or a blockchain generation program) may be separated into separate nodes or modules.

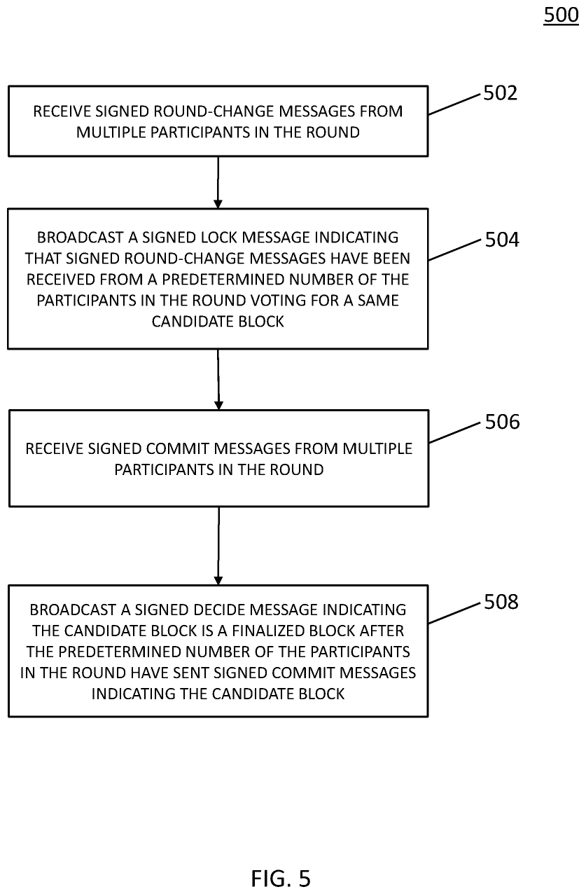

FIG. 5 is a diagram illustrating an example process 500 for providing BFT. In some embodiments, process 500 described herein, or portions thereof, may be performed at or by computer system 400, BFT module 406, processor(s) 402, and/or a module or node. For example, BFT module 406 or computer system 400 may include or be a mobile device, a smartphone, a tablet computer, a computer, a computing platform, or other equipment. In another example, BFT module 406 may include or provide an application running or executing processor(s) 402.

In some embodiments, process 500 may include steps 502-508 and may be performed by or at one or more devices or modules, e.g., a smartphone or computer implemented using at least one processor.

In some embodiments, a computing platform may execute a BFT protocol including process 500. In such embodiments, the computing platform executing process 500 may act as a leader participant of a round of the BFT protocol, e.g., for achieving consensus in bit mining or another distributed computing application.

Referring to process 500, in step 502, signed round-change messages may be received from multiple participants in a round.

In step 504, a signed lock message indicating that signed round-change messages have been received from a predetermined number of the participants in the round voting for a same candidate block may be broadcasted.

In step 506, signed commit messages may be received from multiple participants in the round.

In step 508, a signed decide message indicating the candidate block is a finalized block may be broadcasted after the predetermined number of the participants in the round have sent signed commit messages indicating the candidate block.

In some embodiments, a predetermined number of the participants in a round may include at least 2t+1 participants, where t represents an amount of malicious participants in the round.

In some embodiments, a participant in the round receives the decide message from the leader participant or another participant and sends the decide message to other participants in the round.

In some embodiments, a candidate block may be a maximal acceptable candidate block for a round.

In some embodiments, a leader participant may change for a subsequent round.

In some embodiments, a round may be associated with a blockchain height and a signed decide message may indicate an agreed upon blockchain height (e.g., agreed upon by at least a predetermined number of participants).

In some embodiments, a participant in a round may utilize a round synchronization technique and a height synchronization technique, wherein the round synchronization technique involves the participant incrementing by one a current blockchain height variable associated with the participant in response to receiving the decide message, and wherein the height synchronization technique involves the participant sending a signed round-change message to the leader in response to the participant receiving a signed look message, a commit message, or a decide message for a subsequent round relative to a current round variable associated with the participant.

In some embodiments, a participant in a round may utilize one or more timers, wherein the one or more timers may include an operation timeout timer, a round changing status timer, or a lock status timer, a commit status timer, or a lock release status timer.

In some embodiments, a participant in a round may utilize an application programming interface (API) for obtaining a participant list for the round or a related blockchain height.

In some embodiments, a participant in a round may check a local participant list after receiving a BFT related message.

It will be appreciated that process 500 is for illustrative purposes and that different and/or additional actions may be used. It will also be appreciated that various actions described herein may occur in a different order or sequence.

It should be noted that computer system 400, BFT module 406, and/or functionality described herein may constitute a special purpose computing device. Further, system 400, BFT module 406, and/or functionality described herein can improve the technological field of BFT and/or related consensus applications (e.g., blockchain applications, distributed data storage applications, etc.), by providing mechanisms and/or techniques for providing BFT using algorithm 200 or similar functionality. As such, various BFT techniques and/or mechanisms described herein can provide improved BFT relative to some existing BFT protocols. For example, such BFT techniques and/or mechanisms described herein, e.g., BDLS or algorithm 200, can provide improved liveness and safety in Type II partial synchronous networks and/or other distributed networks.

The disclosure of each of the following references is incorporated herein by reference in its entirety to the extent not inconsistent herewith and to the extent that it supplements, explains, provides a background for, or teaches methods, techniques, and/or systems employed herein.

8.4 Performance Evaluation

In this section, performance of the BDLS consensus algorithm with a Pacemaker module in Section 8.2 implemented using Go Programming Language is evaluated. The implementation is based on algorithm 200 depicted in FIGS. 2A-2C.

A first testing platform utilized for evaluating an implementation of the BDLS consensus algorithm includes an AMD Ryzen 7 2700X eight-core processor with 64 gigabyte (GB) RAM and Linux 4.19.84-microsoft-standard operating system. A second testing platform utilized for evaluating an implementation of the BDLS consensus algorithm includes a BCM2835 Broadcom chip with 4 cores and 1 GB RAM and a Linux raspberry pi 4.19.75-v7I+ operating system (e.g., for approximating performance of the BFT implementation during a heavy load scenario).

Using the two testing platforms, scenarios involving 20 participants, 30 participants, 50 participants, 80 participants, and 100 participants were tested.

During testing, various network scenarios were simulated by changing values for the following parameters:
DELAY.EXP: Expected Latency set to consensus algorithm
DECIDE.AVG: Average finalization time for each height
NET.MSGS: Total network number of messages exchanged in all heights
NET.BYTES: Total network bytes exchanged in all heights
NET.MSGRATE: Network message rate (messages/second)
DELAY.MIN: Actual minimal network latency (network latency is randomized with normal distribution)
DELAY.MAX: Actual maximal network latency.

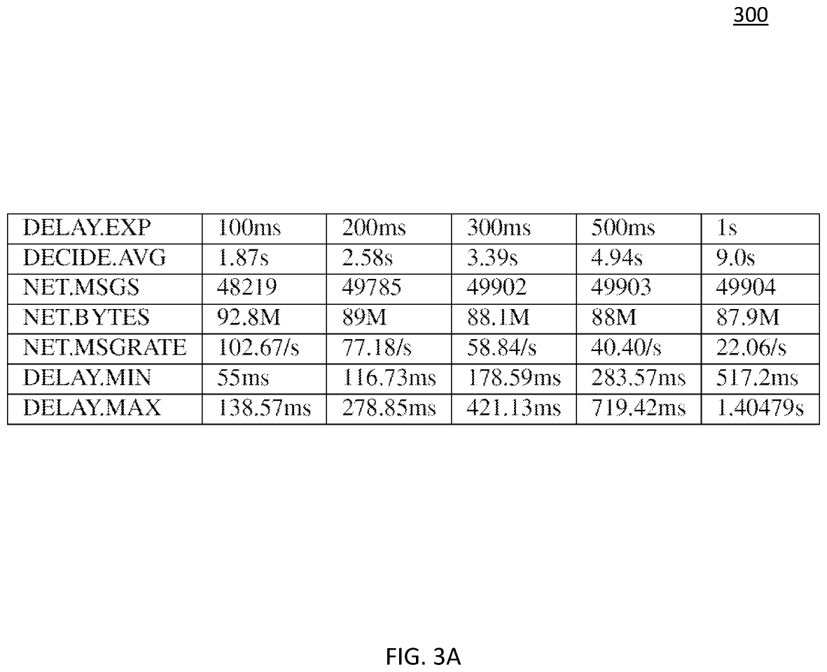

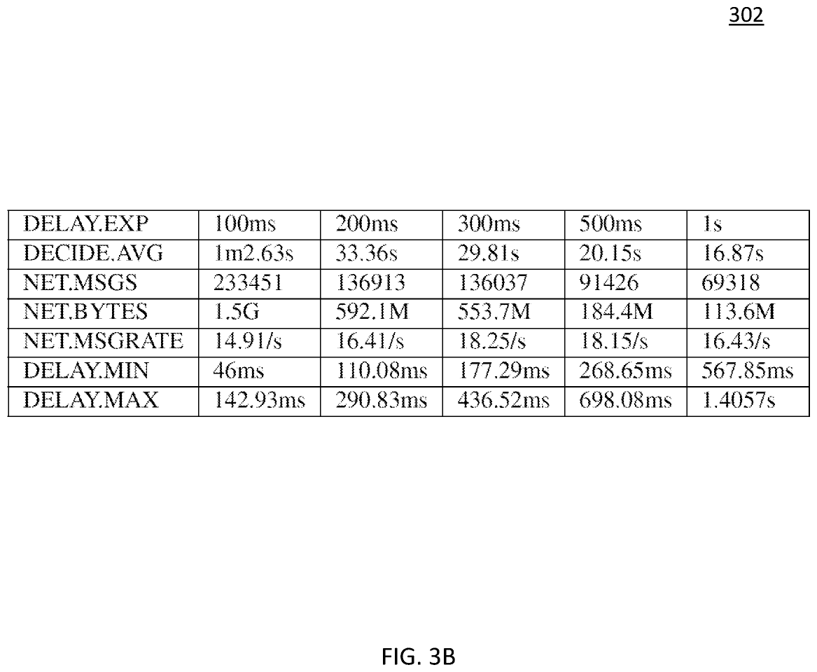

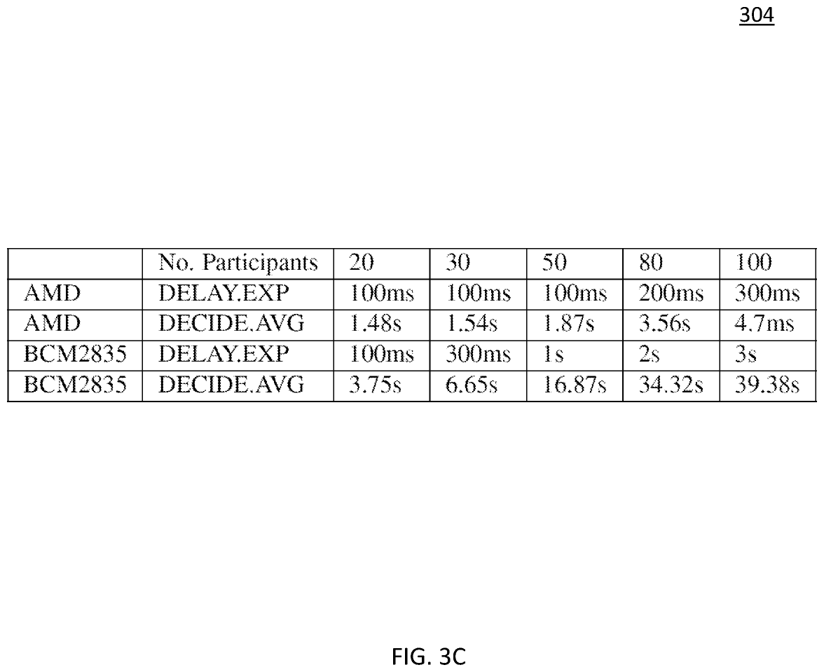

FIGS. 3A-3C depict tables containing information for various test scenarios involving an example BFT implementation, e.g., based on algorithm 200. In FIG. 3A, table 300 shows test results for a 50 participants scenario involving the first testing platform. In FIG. 3B, table 302 shows test results for a 50 participants scenario involving the second testing platform. In FIG. 3C, table 304 shows DELAY.EXP and DECIDE.AVG values for different participant scenarios and testing platforms.

8.5 Static and Dynamic BFT Participants

For blockchain environments, the BFT participants may change from height to height (or even from round to round). In such embodiments, to obtain the BFT participant team, each participant may use an API call to obtain the participant list for the height h before submitting the round-change message for a new height h. However, for a permissionless blockchain, the full participant list may not be available at the time when it submits the round-change message. Thus each time, when a participant receives a BFT message, the participant may check whether the sender of the message is in its local list of participants or not. If not, the participant may use an API to check whether the sender is a qualified participant for this height or not. If the sender is a qualified participant, the participant may expand its participant list and adjust the parameters accordingly.

On the other hand, some applications of BDLS BFT protocol may involve static BFT participants. To make the BDLS package more efficient for these applications, one may use an API call to check whether BFT participants change from round to round. If the participant list does not change, the BLDS protocol may not carry out the extra checks discussed in the preceding paragraph.

9 Importance of Propagating Decision Messages

During Step 5 of the BDLS protocol, when a participant receives a decide message, it propagates the decide message to its neighbors. In this section, we show the importance of this process by the potential issues for the HotStuff protocol since it does not have this decision message propagation process.

9.1 HotStuff BFT Protocol

HotStuff BFT [20] includes basic HotStuff protocol and chained HotStuff protocol. For simplicity, we only review the basic HotStuff BFT protocol. Similar to PBFT and Tendermint BFT, there are n=3t+1 participants P₀, . . . , Pₙ₋₁ and at most t of them are malicious. The view is defined and changes in the same way as in PBFT. The major differences between PBFT and HotStuff BFT are:
1. PBFT participants “broadcast” signed messages to all participants though HotStuff participants send the signed messages to the leader participant in a point-to-point channel. In other words, PBFT uses a mesh topology communication network though HotStuff uses a star topology communication network.
2. PBFT uses standard digital signature schemes though HotStuff uses threshold digital signature schemes.

With these two differences, HotStuff achieves authenticator complexity O(n) for both the correct leader scenario and the faulty leader scenario. On the other hand, the corresponding authenticator complexity for PBFT is O(n²) for the correct leader scenario and O(n³) for the faulty leader scenario respectively. For simplicity, we will describe the HotStuff BFT protocol using a standard digital signature scheme instead of threshold digital signature schemes. Our analysis does not depend on the underlying signature schemes.

HotStuff BFT has revised the validRound and lockedRound variables in Tendermint BFT to its prepareQC and lockedQC variables respectively. Though Tendermint BFT participants set the values for two variables in the same phase, HotStuff BFT participants set the values for these variables in different steps.

In HotStuff BFT, each participant stores a tree of pending commands as its local data structure and keeps the following state variables viewNumber (initially 1), prepareQC(initially nil, storing the highest QC for which it voted pre-commit), and lockedQC (initially nil, storing the highest QC for which it voted commit).

Each time when a new-viewstarts, each participant should send its prepareQC variable to the leader. There is a public function LEADER(viewNumber)that determines the current leader participant. When a client sends an operation request m to the leader Pᵢ, the n participants carry out the four phases of the BFT protocol: prepare, pre-commit, commit and decide.
1. prepare: The leader Pᵢ starts the process after it has received 2t+1 new—viewmessages. Each new—view message contains a prepareQCvariable. Pᵢ selects highQC as the prepareQCvariable with the highest viewNumber. Pᵢ extends the tail of highQC node by creating a new leaf node proposal. Pᵢ then broadcasts the digitally signed new leaf node proposal (together with highQC for safety justification) to all participants in a preparemessage. A participant accepts this new leaf node proposal if the new node extends the currently locked node lockedQC. node or it has a higher view number than the current lockedQC. If a participant Pⱼ accepts the new leaf node proposal, it sends a prepare vote message to Pᵢ by signing it.
2. pre-commit: When Pᵢ receives 2t+1 preparevotes for the current proposal, it combines them into a prepareQC. Pᵢ broadcasts prepareQC in a pre-commit message. A participant sets its prepareQCvariable to this received prepareQC value and votes for it by sending the signed prepareQC back to Pᵢ in a pre-commit message.
3. commit: When Pᵢ receives 2t+1 pre-commitvotes. It combines them into a precommitQC and broadcasts it in a commitmessage. A participant sets its lockedQC variable to this received precommitQC value and votes for it by sending the signed precommitQC back to Pᵢ in a commit message.
4. decide: When Pᵢ receives 2t+1 commitvotes, it combines them into a commitQC. Pᵢ broadcasts commitQC in a decide message. Upon receiving a decide message, a participant considers the proposal embodied in the commitQC a committed decision, and executes the commands in the committed branch. The participant increments viewNumber and starts the next view.

9.2 What Happens if Leader Does not Reliably Broadcast Decide Messages in HotStuff

In the following, we describe three scenarios with completely different semantics where the client receives different responses. However, the HotStuff trees are identical for these three scenarios. First assume that at the end of view v−1, we have lockedQC=prepareQC and the HotStuff path corresponding to lockedQC.node is a₀→a₁→aₗ where a₀ is the root.

Assume that the views v and v+1 are executed before GST. That is, the broadcast channel is not reliable before the end of view v+1. Assume that the leader for view v is Pᵢ and the leader for view v+1 is Pᵢ′. Furthermore, assume that both Pᵢ and Pᵢ′ are malicious,

Scenario I: The leader Pᵢ for view v receives 2t+1 new-view messages that contain the identical highQC=prepareQC with the corresponding path a₀→a₁→aₗ. Pᵢ extends the path to the new path a₀→a₁→aₗ→b and creates a proposal for the new leaf node b. Pᵢ then broadcasts the digitally signed new leaf node proposal (together with highQC) to all participants in a preparemessage. All participant accept this new leaf node proposal and sends a preparevote message to Pᵢ by signing it. In the pre-commit phase, Pᵢ receives 2t+1 preparevotes for the current proposal, it combines them into a prepareQC and broadcasts prepareQC in a pre-commitmessage to all participants. All participant set their prepareQCvariable to this received prepareQC value and vote for it by sending the signed prepareQC back to Pᵢ. During the commit phase, Pᵢ receives 2t+1 pre-commitvotes. It combines them into a precommitQC and broadcasts it in a commitmessage. All participant set their lockedQCvariable to this received precommitQC value and vote for it by sending the signed precommitQC back to Pᵢ. In the decide phase, Pᵢ receives 2t+1 commitvotes, it combines them into a commitQC. Pᵢ only send the commitQC to one honest participant Pj but not to anyone else. After timeout, the view v+1 starts. During view v+1, the leader participant extends the path a₀→a₁→aₗ→b to a₀→a₁→→aₗ→b→c by including a new client command to the node c. Assume that all messages during view v+1 are delivered and all participants behaves honestly. Thus at the end of view v+1, all participants (except Pⱼ) only executed the commands contained the node c and Pⱼ executed the commands contained both in b and c. Since the client only received one response from Pⱼ that the commands in node b is executed, it will not accept it.

Scenario II: In this scenario, the leader participant Pᵢ for view v does not send any decide message in the last step of view v. All other steps are identical to the Scenario I. Thus at the end of view v+1, all participants executed the command contained in the node c though no participants executed the command contained in the node b.

Scenario III: In this scenario, the leader participant Pᵢ for view v sends the decide message to all participants in the last step of view v. All other steps are identical to the Scenario I. Thus at the end of view v+1, all participants executed the commands contained in the nodes b and c.

For all these three scenarios, the path corresponding to the prepareQC at the end of view v+1 is a₀→a₁→aₗ→b→c though the internal states of honest participants are different.

In the HotStuff BFT protocol [20], it is mentioned that “[i]n practice, a recipient who falls behind can catch up by fetching missing nodes from other replicas”. For all three of the scenarios that we have described, at the end of view v+1, the participant who falls behind may fetch the prepareQC corresponding to the path a₀→a₁→aₗ→b→c. But it does not know which scenario has happened. It should be noted that in the HotStuff BFT protocol, the node on the tree only contains the following information: the hash of the parent node and the client command. However, it does not contain any information whether the command has been executed. Our analysis shows that it is important to include in the tree node whether a given command has been executed.

### REFERENCES

[1] M. Ben-Or. Another advantage of free choice: Completely asynchronous agreement protocols (extended abstract). In Proc. 2nd ACM PODC, pages 27-30, 1983.
[2] G. Bracha. An asynchronous [(n−1)/3]-resilient consensus protocol. In Proc. 3rd ACM PODC, pages 154-162. ACM, 1984.
[3] E. Buchman, J. Kwon, and Z. Milosevic. The latest gossip on BFT consensus. Preprint arXiv:1807.04938, 2018.
[4] V. Buterin and V. Griffith. Casper the friendly finality gadget. arXiv preprint arXiv:1710.09437v4, 2019.
[5] M. Castro and B. Liskov. Practical byzantine fault tolerance and proactive recovery. ACM TOCS, 20(4):398-461, 2002.
[6] Cosmos. Cosmos Network: Internet of Blockchains https://cosm os. network.
[7] Yvo Desmedt, Yongge Wang, and Mike Burmester. A complete characterization of tolerable adversary structures for secure point-to-point transmissions without feedback. In International Symposium on Algorithms and Computation, pages 277-287. Springer, 2005.
[8] D. Dolev and H. R. Strong. Polynomial algorithms for multiple processor agreement. In Proc. 14th ACM STOC, pages 401-407. ACM, 1982.
[9] C. Dwork, N. Lynch, and L. Stockmeyer. Consensus in the presence of partial synchrony. JACM, 35(2):288-323, 1988.
[10] M. J. Fischer, N. A Lynch, and M. S. Paterson. Impossibility of distributed consensus with one faulty process. Journal of the ACM (JACM), 32(2):374-382, 1985.
[11] Web3 Foundation. Byzantine finality gadgets, https://research.web3.foundation/en/latest/polkadot/GRANDPA, Apr. 17, 2019.
[12] J. Katz and C.-Y. Koo. On expected constant-round protocols for byzantine agreement. Journal of Computer and System Sciences, 75(2):91-112, 2009.
[13] J. Kwon. Tendermint powers 40%+ of all proof-of-stake blockchains. invest: asia, available at https://realsatoshi.net/12886/, Sep. 12, 2019.
[14] L. Lamport, R. Shostak, and M. Pease. The Byzantine generals problem. ACM Transactions on Programming Languages and Systems (TOPLAS), 4(3):382-401, 1982.
[15] M. Pease, R. Shostak, and L. Lamport. Reaching agreement in the presence of faults. Journal of the ACM (JACM), 27(2):228-234, 1980.
[16] TK Srikanth and S. Toueg. Simulating authenticated broadcasts to derive simple fault-tolerant algorithms. Distributed Computing, 2(2):80-94, 1987.
[17] The LibraBFT Team. State machine replication in the Libra Blockchain. available at https://developers.libra.org/docs/assets/papers/libra-consensus-state-machine-replication-in-the-libra-blockchain/2019-11-08. pdf, Nov. 28, 2019.
[18] Y. Wang and Y. Desmedt. Secure communication in multicast channels: the answer to Franklin and Wright's question. Journal of Cryptology, 14(2):121-135, 2001.
[19] Y. Wang and Y. Desmedt. Perfectly secure message transmission revisited. Information Theory, IEEE Tran., 54(6):2582-2595, 2008.
[20] M. Yin, D. Malkhi, M.K. Reiter, G.G. Gueta, and I. Abraham. HotStuff:

BFT consensus in the lens of blockchain. arXiv preprint arXiv:1803.05069, 2018.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for providing Byzantine fault tolerance (BFT), the method comprising:
at a computing platform executing a BFT protocol, wherein the computing platform is acting as a leader participant of a round of the BFT protocol:
receiving signed round-change messages from multiple participants in the round;
broadcasting a signed lock message indicating that signed round-change messages have been received from a predetermined number of the participants in the round voting for a same candidate block;
receiving signed commit messages from multiple participants in the round; and
broadcasting a signed decide message indicating the candidate block is a finalized block after the predetermined number of the participants in the round have sent signed commit messages indicating the candidate block.

2. The method of claim 1 wherein the predetermined number of the participants includes at least 2t+1 participants, where t represents an amount of malicious participants in the round.

3. The method of claim 1 wherein a participant in the round receives the decide message from the leader participant or another participant and sends the decide message to other participants in the round.

4. The method of claim 1 wherein the candidate block is a maximal acceptable candidate block for the round.

5. The method of claim 1 wherein the leader participant changes for a subsequent round.

6. The method of claim 1 wherein the round is associated with a blockchain height and wherein the signed decide message indicates an agreed upon blockchain height.

7. The method of claim 1 wherein a participant in the round utilizes a round synchronization technique and a height synchronization technique, wherein the round synchronization technique involves the participant incrementing by one a current blockchain height variable associated with the participant in response to receiving the decide message, and wherein the height synchronization technique involves the participant sending a signed round-change message to the leader in response to the participant receiving a signed look message, a commit message, or a decide message for a subsequent round relative to a current round variable associated with the participant.

8. The method of claim 1 wherein a participant in the round utilizes one or more timers, wherein the one or more timers includes an operation timeout timer, a round changing status timer, or a lock status timer, a commit status timer, or a lock release status timer.

9. The method of claim 1 wherein a participant in the round utilizes an application programming interface (API) for obtaining a participant list for the round or a related blockchain height or wherein the participant in the round checks a local participant list after receiving a BFT related message.

10. A system for providing Byzantine fault tolerance (BFT), the system comprising:
at least one processor; and
a computing platform implemented using the at least one processor, wherein the computing platform is executing a BFT protocol, wherein the computing platform is acting as a leader participant of a round of the BFT protocol, wherein the computing platform is configured for:
receiving signed round-change messages from multiple participants in the round;
broadcasting a signed lock message indicating that signed round-change messages have been received from a predetermined number of the participants in the round voting for a same candidate block;
receiving signed commit messages from multiple participants in the round; and
broadcasting a signed decide message indicating the candidate block is a finalized block after the predetermined number of the participants in the round have sent signed commit messages indicating the candidate block.

11. The system of claim 10 wherein the predetermined number of the participants includes at least 2t+1 participants, where t represents an amount of malicious participants in the round.

12. The system of claim 10 wherein a participant in the round receives the decide message from the leader participant or another participant and sends the decide message to other participants in the round.

13. The system of claim 10 wherein the candidate block is a maximal acceptable candidate block for the round.

14. The system of claim 10 wherein the leader participant changes for a subsequent round.

15. The system of claim 10 wherein the round is associated with a blockchain height and wherein the signed decide message indicates an agreed upon blockchain height.

16. The system of claim 10 wherein a participant in the round utilizes a round synchronization technique and a height synchronization technique, wherein the round synchronization technique involves the participant incrementing by one a current blockchain height variable associated with the participant in response to receiving the decide message, and wherein the height synchronization technique involves the participant sending a signed round-change message to the leader in response to the participant receiving a signed look message, a commit message, or a decide message for a subsequent round relative to a current round variable associated with the participant.

17. The system of claim 10 wherein a participant in the round utilizes one or more timers, wherein the one or more timers includes an operation timeout timer, a round changing status timer, or a lock status timer, a commit status timer, or a lock release status timer.

18. The system of claim 10 wherein a participant in the round utilizes an application programming interface (API) for obtaining a participant list for the round or a related blockchain height or wherein the participant in the round checks a local participant list after receiving a BFT related message.

19. A non-transitory computer readable medium having stored thereon executable instructions that when executed by a processor of a computer cause the computer to perform steps comprising:
at a computing platform executing a Byzantine fault tolerance (BFT) protocol, wherein the computing platform is acting as a leader participant of a round:
receiving signed round-change messages from multiple participants in the round;
broadcasting a signed lock message indicating that signed round-change messages have been received from a predetermined number of the participants in the round voting for a same candidate block;
receiving signed commit messages from multiple participants in the round; and
broadcasting a signed decide message indicating the candidate block is a finalized block after the predetermined number of the participants in the round have sent signed commit messages indicating the candidate block.

20. The non-transitory computer readable medium of claim 19 wherein the predetermined number of the participants includes at least 2t+1 participants, where t represents an amount of malicious participants in the round.
